(19) United States
(12) Patent Application Publication
(10) Pub. No.: US 2026/0034449 A1
(43) Pub. Date: Feb. 5, 2026

(54) ACTION DECISION-MAKING METHOD AND APPARATUS FOR VIRTUAL CHARACTER, DEVICE, AND STORAGE MEDIUM

(71) Applicant: Tencent Technology (Shenzhen) Company Limited, Shenzhen (CN)

(72) Inventors: Huan HU, Shenzhen (CN); Sze Yeung LIU, Shenzhen (CN); Ruochen LIU, Shenzhen (CN); Yuan ZHOU, Shenzhen (CN)

(21) Appl. No.: 19/353,443

(22) Filed: Oct. 8, 2025

Related U.S. Application Data
(63) Continuation of application No. PCT/CN2024/106547, filed on Jul. 19, 2024.

(30) Foreign Application Priority Data
Sep. 15, 2023 (CN) 202311198980.6

(51) Int. Cl. A63F 13/55; G06F 18/25; G06N 3/092

(52) U.S. Cl. CPC A63F 13/55; G06F 18/25; G06N 3/092

(57) ABSTRACT

An action decision-making method for a virtual character is performed by a computer device. The method includes: obtaining character status information of a first virtual character and environmental perception information of the first virtual character with respect to a virtual environment in which the first virtual character is currently located; fusing the character status information and the environmental perception information, to obtain a fusion feature; determining a character action for the first virtual character by applying the fusion feature to an action decision-making model; and controlling the first virtual character to execute the character action.

### CROSS-REFERENCE TO RELATED APPLICATIONS

This application is a continuation application of PCT Patent Application No. PCT/CN2024/106547, entitled “ACTION DECISION-MAKING METHOD AND APPARATUS FOR VIRTUAL CHARACTER, DEVICE, AND STORAGE MEDIUM” filed on Jul. 19, 2024, which claims priority to Chinese Patent Application No. 202311198980.6, entitled “ACTION DECISION-MAKING METHOD AND APPARATUS FOR VIRTUAL CHARACTER, DEVICE, AND STORAGE MEDIUM” filed on Sep. 15, 2023, all of which are incorporated herein by reference in their entirety.

### FIELD OF THE TECHNOLOGY

Embodiments of this application relate to the field of artificial intelligence (AI) technologies, and in particular, to an action decision-making method and apparatus for a virtual character, a device, and a storage medium.

### BACKGROUND OF THE DISCLOSURE

Nowadays, during planning of a video game, behavioral logic of a non-player character (NPC) is usually expected to be consistent with behavioral logic of a real player as much as possible. That is, the NPC in the game is enabled to have a highly humanoid characteristic.

In the related art, when behavioral logic of a virtual character is determined based on a neural network model, behavior of the virtual character is usually predicted based on attribute information of the current virtual character in a virtual environment and virtual environment information. Virtual environment information of a virtual environment in which the current virtual character is located may be determined by performing image recognition on a raw pixel image of the current virtual environment. Then the virtual environment information is inputted to the neural network model, and the virtual character is controlled to perform an action outputted by the neural network model.

However, some virtual environments have a large scale, and scene content of the virtual environment is complex. For example, various moving obstacles such as airplanes, automobiles, and virtual characters exist in the virtual environment. If virtual environment information is determined by performing image recognition on an image of the current virtual environment, a large amount of resources need to be consumed for capturing the image of the virtual environment, leading to high complexity of determining an action of a virtual character and high labor costs.

### SUMMARY

Embodiments of this application provide an action decision-making method and apparatus for a virtual character, a device, and a storage medium. Technical solutions are as follows:

According to one aspect, embodiments of this application provide an action decision-making method for a virtual character, performed by a computer device. The method includes:
obtaining character status information of a first virtual character and environmental perception information of the first virtual character with respect to a virtual environment in which the first virtual character is currently located;
fusing the character status information and the environmental perception information into a fusion feature;
determining a character action for the first virtual character by applying the fusion feature to an action decision-making model; and
controlling the first virtual character to execute the character action.

According to another aspect, embodiments of this application provide a computer device. The computer device includes a processor and a memory. The memory has at least one instruction, at least one program, a code set, or an instruction set stored therein. The at least one instruction, the at least one program, the code set, or the instruction set, when loaded and executed by the processor, causes the computer device to implement the action decision-making method for a virtual character according to the foregoing aspect.

According to another aspect, a non-transitory computer-readable storage medium is provided. The readable storage medium has at least one instruction, at least one program, a code set, or an instruction set stored therein. The at least one instruction, the at least one program, the code set, or the instruction set, when loaded and executed by a processor of a computer device, causing the computer device to implement the action decision-making method for a virtual character according to the foregoing aspect.

The technical solutions provided in the embodiments of this application have at least the following beneficial effects:

In the embodiments of this application, when action decision-making needs to be performed on a first virtual character in a virtual environment, character status information and multimodal environmental perception information of the first virtual character are obtained, so that feature coding and fusion are performed on the character status information and the multimodal environmental perception information, and action decision-making is finally performed based on the fusion feature. During action decision-making, environmental perception information of different information dimensions that is perceived by the first virtual character is obtained. This helps obtain a more comprehensive and detailed three-dimensional virtual environment around the first virtual character, so that more appropriate action decision-making can be performed. Feature coding is performed on the character status information and perception information of a plurality of different modalities by using different coding schemes, so that an action decision-making model can more accurately fit various types of information in a current scenario. In addition, compared with a manner of obtaining an environment feature through image recognition in the related art, feature extraction is performed on quantized multimodal environmental perception information, and then a coding result of the character status information is fused. This helps more comprehensively consider the character status information of the first virtual character while quantizing the environmental perception information, to improve accuracy of a character action obtained through decision-making while saving computing resources, and make effect of executing the character action by the first virtual character more vivid.

### BRIEF DESCRIPTION OF THE DRAWINGS

FIG. 1 is a schematic diagram of an implementation environment according to an exemplary embodiment of this application.

FIG. 2 is a flowchart of an action decision-making method for a virtual character according to an exemplary embodiment of this application.

FIG. 3 is a schematic diagram of a ray detection scheme according to an exemplary embodiment of this application.

FIG. 4 is a schematic diagram of second-modality perception information according to an exemplary embodiment of this application.

FIG. 5 is a schematic diagram of a structure of an occupancy grid according to an exemplary embodiment of this application.

FIG. 6 is a flowchart of a process of generating a character action according to an exemplary embodiment of this application.

FIG. 7 is a schematic diagram of a process of performing one-dimensional convolution on environmental perception information according to an exemplary embodiment of this application.

FIG. 8 is a schematic diagram of a user interface of an application for providing a virtual environment according to an exemplary embodiment of this application.

FIG. 9 is a schematic diagram of a moving direction and a description of sub-action composition of an action according to an exemplary embodiment of this application.

FIG. 10 is a schematic diagram of an autoregressive structure of n action output heads according to an exemplary embodiment of this application.

FIG. 11 is a schematic diagram of visibility status perception according to an exemplary embodiment of this application.

FIG. 12 is a schematic diagram of determining an effective aiming range in a vertical direction according to an exemplary embodiment of this application.

FIG. 13 is a schematic diagram of an effective aiming range in a horizontal direction according to an exemplary embodiment of this application.

FIG. 14 is a schematic diagram of an action decision-making model according to an exemplary embodiment of this application.

FIG. 15 is a flowchart of a training process of an action decision-making model according to an exemplary embodiment of this application.

FIG. 16 is a schematic diagram of performing area division on a depth map according to an exemplary embodiment of this application.

FIG. 17 is a schematic diagram of a character action including a turning sub-action according to an exemplary embodiment of this application.

FIG. 18 is a schematic structural diagram of an action decision-making apparatus for a virtual character according to an exemplary embodiment of this application.

FIG. 19 is a schematic structural diagram of a computer device according to an exemplary embodiment of this application.

### DESCRIPTION OF EMBODIMENTS

To make the objectives, technical solutions, and advantages of this application clearer, the following further describes implementations of this application in detail with reference to the accompanying drawings.

Embodiments of this application relate to AI and machine learning (ML) technologies, and are designed based on ML in AI.

AI involves a theory, a method, a technology, and an application system that use a digital computer or a machine controlled by a digital computer to simulate, extend, and expand human intelligence, perceive an environment, obtain knowledge, and use the knowledge to obtain an optimal result. AI technologies such as reinforcement learning (RL) and deep learning are widely used in various fields. For example, this application relates to an RL technology in ML.

RL is a branch of ML. An agent performs learning by interacting with an environment. This is a result-oriented learning process. The agent is not informed of an action to be taken; instead, the agent learns from a result of its action.

The agent can perceive an environment through a sensor and act on the environment through an executor. For each possible percept sequence, the agent is to select an action to execute, and the action can enable performance of the agent to reach an expected maximum value when the action has an evidence provided by a directive and the percept sequence. In the embodiments of this application, a first virtual character serves as an agent to perceive a virtual environment, obtain multimodal environmental perception information, and execute a character action determined by an action decision-making model.

The virtual environment is a virtual environment displayed (or provided) when an application runs on a computer device. The virtual environment may be a simulated environment of the real world, a semi-simulated and semi-fictional environment, or a completely fictional environment. The virtual environment may be any one of a two-dimensional virtual environment, a 2.5-dimensional virtual environment, and a three-dimensional virtual environment. This is not limited in this application. The following embodiments are described by using an example in which the virtual environment is a three-dimensional virtual environment.

A virtual character is a movable object in the virtual environment. The movable object may be at least one of a virtual character, a virtual animal, and a cartoon character. In some embodiments, when the virtual environment is a three-dimensional virtual environment, the virtual character may be a three-dimensional virtual model, and each virtual character has a shape and a volume in the three-dimensional virtual environment, and occupies a part of space in the three-dimensional virtual environment. In some embodiments, the virtual character is a three-dimensional character built based on a three-dimensional human skeleton technology. The virtual character shows different external images through different skins. In some implementations, the virtual character may alternatively be implemented by using a 2.5-dimensional model or a two-dimensional model. This is not limited in the embodiments of this application.

In the related art, raw pixels are used for environmental perception. In a manner of performing image recognition based on raw pixel information, image data needs to be collected from a client, and then image recognition is further performed to obtain a status of a virtual environment. However, some virtual environments have a large scale, and scene content of the virtual environment is complex. For example, various moving obstacles such as airplanes, automobiles, and virtual characters exist in the virtual environment. If virtual environment information is determined by performing image recognition on an image of the current virtual environment, a large amount of resources need to be consumed for capturing the image of the virtual environment, leading to high complexity of determining an action of a virtual character and high labor costs.

In addition, in the related art, a plurality of rays may be transmitted in a navigation grid of a location of a virtual character. The rays stop when encountering an edge of the navigation grid. Then several path-finding points are selected based on a scene query system, to ensure accessibility to the virtual character. However, a manner of querying discrete points provides the first virtual character only with several path-finding points for reaching a destination, but cannot clearly express a surrounding environment feature. This is not conducive to obtaining a surrounding environment feature by a deep neural network. In addition, when the deep neural network performs action decision-making at a high frame rate, the virtual character is pulled and swings between different path-finding points, leading to twitching of the virtual character. Therefore, the embodiments of this application provide an action decision-making method for a virtual character. A finer-grained environment feature can be obtained by obtaining a multimodal environmental perception feature perceived by a first virtual character, to fuse a surrounding environment and a status feature of the first virtual character to obtain a fusion feature. Then action decision-making is performed based on the fusion feature, to control an action of the first virtual character.

A computer device in this application may be a desktop computer, a laptop programming computer, a mobile phone, a tablet computer, an e-book reader, a moving picture experts group audio layer III (MP3) player, a moving picture experts group audio layer IV (MP4) player, an intelligent voice interaction device, an intelligent home appliance, an in-vehicle terminal, or the like. An application supporting a virtual environment, for example, an application supporting a three-dimensional virtual environment, is installed and run on the computer device. The application may be any one of a virtual reality (VR) application, a three-dimensional map program, a third-person shooter (TPS) game, a first-person shooter (FPS) game, and a multiplayer online battle arena (MOBA) game. In some embodiments, the application may be a standalone application, for example, a standalone 3D game program, or may be an online application. The following embodiments are described by using an application in a game as an example.

A game based on a virtual environment usually includes maps of one or more game worlds. The virtual environment in the game simulates a real-world scene, and a first virtual character may perform the following actions in the virtual environment: walking, running, jumping, shooting, combating, driving, climbing, gliding, switching a virtual item to use, attacking another virtual character by using a virtual item, and the like.

FIG. 1 is a schematic diagram of an implementation environment according to an exemplary embodiment of this application. The implementation environment may include a terminal 110, a first server 120, and a second server 130.

In this embodiment of this application, the terminal 110 includes, but is not limited to, the following devices: a mobile phone, a tablet computer, a notebook computer, a desktop computer, an e-book reader, an intelligent voice interaction device, an intelligent home appliance, an in-vehicle terminal, and the like. An application 111 supporting a virtual environment is run on the terminal 110, and the application may be a TPS game or an FPS game. When the terminal 110 runs the application 111, a user interface of the application 111 is displayed on a screen of the terminal 110. A user controls, by using the terminal 110, a virtual character located in the virtual environment to perform an activity. Alternatively, the terminal controls an NPC located in the virtual environment to perform an activity. The activity of the virtual character includes, but is not limited to, at least one of the following: adjusting a body posture, crawling, walking, running, riding, flying, jumping, driving, picking, shooting, attacking, throwing, and releasing a skill.

The first server 120 may be an independent physical server, or may be a server cluster or a distributed system that includes a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an AI platform. In this embodiment of this application, the first server 120 is configured to provide a background service for an application supporting a three-dimensional virtual environment, and may be a dedicated server (DS). In some embodiments, the first server 120 is in charge of primary computing work, and the terminal is in charge of secondary computing work; or the first server 120 is in charge of secondary computing work, and the terminal is in charge of primary computing work; or the first server 120 and the terminal perform collaborative computing by using a distributed computing architecture.

The second server 130 may be an independent physical server, or may be a server cluster or a distributed system that includes a plurality of physical servers, or may be a cloud server that provides basic cloud computing services such as a cloud service, a cloud database, cloud computing, a cloud function, cloud storage, a network service, cloud communication, a middleware service, a domain name service, a security service, a CDN, big data, and an AI platform. In this embodiment of this application, the second server 130 is configured to provide a virtual character action decision-making service for an application supporting a three-dimensional virtual environment. When the action decision-making service provided by the second server 130 is enabled, an address of the second server 130 is registered in ETCD, a distributed key-value store. When action decision-making needs to be performed for a virtual character, the first server 120 initiates, to a service scheduler, a request for connecting to an inference service, and obtains an address of the action decision-making service that is returned by the service scheduler. Therefore, the first server 120 transmits, by using the obtained address, an action decision-making request to the action decision-making service provided by the second server 130. The inference service returns an action instruction to the first server 120 after determining a character action.

In some embodiments, an action decision-making method for a virtual character is performed by an action decision-making model. During training of the action decision-making model, the second server 130 trains the action decision-making model through RL based on character status information and multimodal environmental perception information in the action decision-making request transmitted by the first server 120.

The embodiments of this application may be applied to the following scenes in a virtual environment: a navigation scene for a first virtual character, a scene in which a character action completes a specified task, or a battle scene of a first virtual character and another virtual character. This is not limited in this embodiment. The following describes an exemplary application process of the embodiments of this application in a virtual scene.

The action decision-making method for a virtual character provided in the embodiments of this application is applied to a game scene. When action decision-making needs to be performed for a first virtual character in the game scene, the terminal 110 or the first server 120 obtains character status information of the first virtual character and multimodal environmental perception information of the first virtual character with respect to a virtual environment in which the first virtual character is currently located, and the second server 130 determines, based on the character status information and the environmental perception information, a character action to be executed by the first virtual character. If the action decision-making method for a virtual character is performed by an action decision-making model, during training of the action decision-making model, sample character status information and sample environmental perception information of the first virtual character are obtained, and the sample character status information and the sample environmental perception information are inputted to the action decision-making model, to train the action decision-making model.

The embodiments of this application may be further applied to a plurality of AI scenarios. The foregoing implementation environment is merely an example, and does not constitute a limitation on an application scenario of the embodiments of this application. For ease of description, the following embodiments are described by using an example in which an action decision-making method for a virtual character in a virtual scene is performed by a computer device.

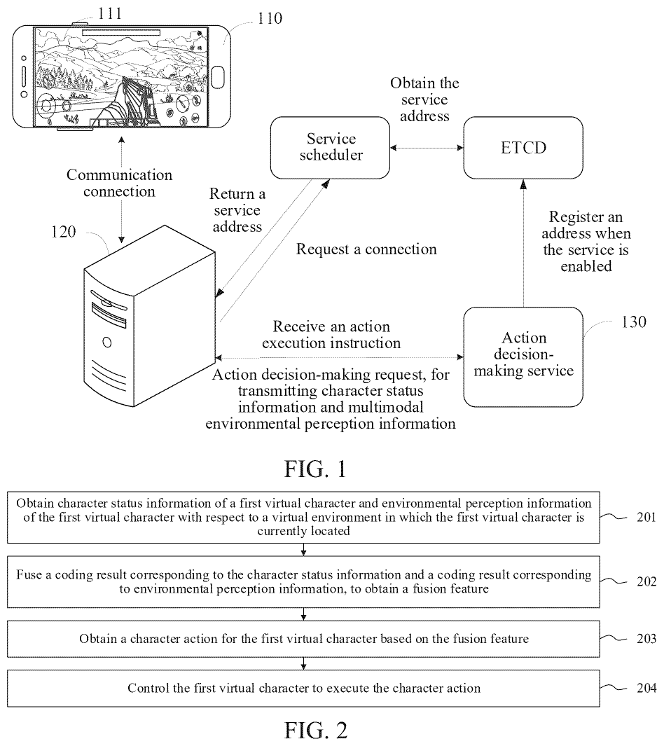

FIG. 2 is a flowchart of an action decision-making method for a virtual character according to an exemplary embodiment of this application. This embodiment is described by using an example in which the method is applied to a computer. The method includes the following operations:

Operation 201: Obtain character status information of a first virtual character and environmental perception information of the first virtual character with respect to a virtual environment in which the first virtual character is currently located.

For example, the first virtual character is any virtual character in the virtual environment. In some embodiments, the first virtual character is a main control virtual character, for example, a virtual hero or a virtual mount, controlled by a player; or the first virtual character is an automatic virtual character automatically controlled by a system, for example, a virtual character automatically controlled and executed when a player is in an away-from-keyboard state.

The environmental perception information includes perception information of a plurality of modalities, and the plurality of modalities each represent one information dimension. Therefore, the environmental perception information may also be referred to as multimodal environmental perception information, and perception information of different modalities in the multimodal environmental perception information has different information dimensions.

In a game scene, a computer device extracts useful information in the game scene. The useful information includes at least the character status information and the environmental perception information that correspond to the first virtual character. The character status information is current attribute information of the first virtual character, interaction information generated through interaction between the first virtual character and another virtual character, and interaction information generated through interaction between the first virtual character and an environment, and can indicate a current status of the first virtual character.

The character status information is a one-dimensional vector, namely, a vector feature. In the game scene, the character status information may be directly obtained from a game engine interface. In addition, a part of the character status information may alternatively be obtained through ray detection.

In the game scene, frames that are run per second during running of the game are referred to as game frames. During running of each game frame, the computer device obtains current character status information and current environmental perception information. Alternatively, the computer device obtains current character status information and current environmental perception information based on a specific periodicity interval. A larger quantity of game frames indicates smoother interface display. The quantity of game frames may be 36. In this case, the computer device obtains 36 frames of character status information and current environmental perception information per second. However, when the quantity of frames is large, for example, when the quantity of frames is 72, a high requirement is imposed on performance of the computer device. In this case, a periodicity may be set to 3. To be specific, one frame of information is obtained from every three game frames, and 24 frames of character status information and current environmental perception information are obtained every second.

For example, Table 1 shows classification of character status information according to an exemplary embodiment of this application.

TABLE 1

| <<Attribute information>> | <<Interaction information> |
|---|---|
| <Common for opponent virtual | <Between the first virtual character and an |
| characters> | opponent virtual character> |
| Health point | Whether damage occurs |
| Location | Whether the character is visible within a field of |
| | view |
| Orientation | Whether an attack is evaded |
| Current quantity of current items | Euclidean distance |
| Camp | Path-finding distance |
| Whether an attack is initiated | Based on an orientation of the first virtual |
| | character × relative coordinates of a distance |
| Whether steps are silent | Attack distance |
| Whether movement is performed | <Between the first virtual character and a bunker> |
| Whether sprinting is performed | Whether the character is in the bunker |
| Whether an item is switched | Whether the bunker is safe |
| Whether crouching is performed | Path-finding distance |
| Whether jumping is performed | Euclidean distance |
| Whether leaning is performed | Relative coordinates of the bunker |
| Whether the character goes prone | <Between the first virtual character and an |
| | obstacle> |
| Whether a gun is held | Whether ray occlusion occurs |
| Whether the character is out | Relative distance |

Perception information of different modalities in the environmental perception information may be obtained in different manners. In addition, in an action decision-making model, perception information of different modalities may also be obtained in different manners. The environmental perception information is configured for obtaining more comprehensive three-dimensional virtual environment features. In some embodiments, the computer device may obtain character status information and environmental perception information of a virtual character when each frame of game picture is displayed. Alternatively, the computer device may obtain character status information and environmental perception information after displaying of every N frames of game pictures ends. Obtaining a feature at high frequency enables more abundant information to be obtained during action prediction, so that a character action is more accurately determined. Obtaining a feature at low frequency can prevent the first virtual character from receiving a new character action when the first virtual character has not completed execution of a first character action. If the execution of the first character action is interrupted, an error may occur in controlling the virtual character to execute the action. For example, the computer device may obtain character status information and environmental perception information of each frame. If an action decision-making process is specified by the action decision-making model, character status information and environmental perception information that are obtained from the fourth frame may be inputted to the action decision-making model.

Operation 202: Fuse a coding result corresponding to the character status information and a coding result corresponding to environmental perception information, to obtain a fusion feature.

For example, feature extraction is performed on the coding result corresponding to the character status information, feature extraction is performed on the coding result corresponding to the environmental perception information, and the two coding results are fused to obtain the fusion feature. The coding result is a result obtained by separately performing feature coding on the character status information and a plurality of pieces of perception information by using different coding schemes.

In some embodiments, a feature extraction process is performed by using a coding network (also referred to as a coder). The character status information and the environmental perception information are inputted to a same coding network. However, the character status information and the environmental perception information are separately analyzed by using different coding schemes, to obtain the coding result corresponding to the character status information and the coding result corresponding to the environmental perception information. The coding scheme includes at least one of a plurality of schemes such as convolutional coding, cyclic coding, autocoder coding, and attention coding. Different coding schemes include independent application or combined application of the foregoing coding schemes.

In some embodiments, a feature extraction process is performed by using a coding network, and the character status information and the environmental perception information are separately inputted to different coding networks that use different coding schemes, to obtain the coding result corresponding to the character status information and the coding result corresponding to the environmental perception information. In some embodiments, the environmental perception information includes perception information of a plurality of modalities, the plurality of modalities each represent one information dimension, and the information dimension is configured for representing a dimension for measuring information. For example, different information sources correspond to different information dimensions, or different information obtaining manners correspond to different information dimensions. Therefore, during coding of the environmental perception information, the perception information of the plurality of modalities is separately coded. For example, in a process of performing feature extraction by using a coding network, the character status information and the perception information of the plurality of modalities are separately inputted to different coding networks that use different coding schemes, and the coding result corresponding to the character status information and coding results respectively corresponding to the perception information of the plurality of modalities are outputted. The coding results of the perception information of the plurality of modalities may be collectively referred to as the coding result of the environmental perception information.

In some embodiments, an action decision-making process is performed by an action decision-making model, and the action decision-making model includes a coding network and a decision-making network. The coding network is configured to code input information, and the decision-making network is configured to determine a character action. Because perception information of different modalities has different information dimensions, the coding network includes convolution kernels of different dimensions, so that the perception information of different modalities is respectively coded by using the convolution kernels of different dimensions.

An ML algorithm performs linear algebraic calculation on a matrix. Therefore, a feature participating in the calculation needs to be of a numerical type. However, non-numerical information exists in the input character status information and multimodal environmental perception information. Therefore, the non-numerical information needs to be coded. For example, a character status in the foregoing table may be converted into a numerical feature through label coding or one-hot coding.

After the character status information and the environmental perception information are separately coded, two coding results are obtained. After feature concatenation is performed on the two coding results, feature extraction is performed based on a convolutional neural network to obtain a fusion feature. The convolutional neural network may be a long short-term memory (LSTM) network. Through feature extraction, a dimension of feature data can be reduced, and information that is more suitable for action decision-making can be extracted from the feature.

Operation 203: Obtain a character action for the first virtual character based on the fusion feature.

In some embodiments, when the character action is determined based on the fusion feature, the process is implemented by selecting, from candidate actions, an optimal action that is suitable to be executed in a current scenario. For example, a plurality of candidate actions are preset, and at least one candidate action is selected from the plurality of candidate actions as the character action based on the fusion feature. For example, candidate action features respectively corresponding to the plurality of candidate actions are extracted, feature similarities between the fusion feature and the plurality of candidate action features are determined through comparison (for example, a cosine value between features is determined), and at least one candidate action with a largest feature similarity is used as the character action.

In some embodiments, if an action decision-making process is performed by an action decision-making model, during training of the action decision-making model, a model parameter may be continuously adjusted, based on the fusion feature, for a decision-making network that is in the action decision-making model and that is configured to perform action decision-making, to learn optimal decisions in various scenarios, in other words, learn optimal actions in various scenarios.

In some embodiments, the decision-making network is a network layer in the action decision-making model, and is configured to determine a character action based on a policy. The policy defines a behavior performed by an agent for a given state, to be specific, defines a behavior performed by the first virtual character for given character status information and environmental perception information. A training process of the action decision-making model may be understood as a process of adjusting a policy in the decision-making network based on a reward brought by a determined estimated character action.

For example, in a process of performing action decision-making by using the decision-making network, first, a probability distribution between different sub-actions in each action type is determined based on the fusion feature, and then an object sub-action in each action type is determined based on the probability distribution.

In a possible implementation, in a game scene, a developer sets cooldown time for some sub-actions. When the cooldown time has not ended, a cooldown state of the sub-action is also inputted to the action decision-making model as the character status information of the first virtual character, to reduce an execution probability of the sub-action in the probability distribution determined by the decision-making network, and avoid a case that the object sub-action determined by the decision-making model cannot be executed.

Operation 204: Control the first virtual character to execute the character action.

For example, the character action determined based on the fusion feature is an action that the first virtual character is controlled to execute in the virtual environment. In some embodiments, the character action includes at least one of a plurality of actions such as a walking action, a running action, a jumping action, a crawling forward action, a knee bending action, a stooping action, a hurdling action, and a head shaking action. That is, the character action includes an overall action of body parts of the first virtual character, or includes a partial action of at least one part. An action form of the character action is not limited herein.

In some embodiments, for example, an action decision-making model performs an action decision-making process and determines a character action. The action decision-making model is deployed on a second server. When the character action is determined by the action decision-making model, an action instruction is transmitted to a first server that provides a background service for an application supporting a virtual environment, and then the first server transmits the action execution instruction to a client, to control the first virtual character to execute the character action.

In a possible implementation, the computer device separately codes sub-action names in different action types, to obtain a plurality of candidate action labels. The computer device obtains a probability distribution of sub-actions in each action type based on the decision-making network in the action decision-making model, and determines, from sub-action labels based on an action execution probability, a label corresponding to an object sub-action. When an object sub-action label is determined, the computer device decodes the object sub-action label to obtain an object sub-action, and controls the first virtual character to execute a character action including a plurality of object sub-actions.

To sum up, when action decision-making needs to be performed on a first virtual character in a virtual environment, character status information and multimodal environmental perception information of the first virtual character are obtained, so that feature coding and fusion are performed on the character status information and the multimodal environmental perception information, and action decision-making is finally performed based on the fusion feature. During action decision-making, environmental perception information of different information dimensions that is perceived by the first virtual character is obtained. This helps obtain a more comprehensive and detailed three-dimensional virtual environment around the first virtual character, so that more appropriate action decision-making can be performed. Feature coding is performed on the character status information and perception information of a plurality of different modalities by using different coding schemes, so that an action decision-making model can more accurately fit various types of information in a current scenario. In addition, compared with a manner of obtaining an environment feature through image recognition in the related art, feature extraction is performed on quantized multimodal environmental perception information, and then a coding result of the character status information is fused. This helps more comprehensively consider the character status information of the first virtual character while quantizing the environmental perception information, to improve accuracy of a character action obtained through decision-making while saving computing resources, and make effect of executing the character action by the first virtual character more vivid.

In this embodiment of this application, the environmental perception information includes first-modality perception information, second-modality perception information, and third-modality perception information. Perception information of different modalities is obtained in different manners. The following describes manners of obtaining perception information of different modalities.
1. Obtain the first-modality perception information.

The first-modality perception information is one-dimensional vector information, and the first-modality perception information is configured for representing a depth status of an obstacle at a same horizontal height around the first virtual character. In a possible implementation, the first-modality perception information is obtained through ray detection based on a character location of the first virtual character in the virtual environment.

For example, the character location is configured for representing location information of a location of the first virtual character in the virtual environment. In some embodiments, the character location is represented by location coordinates of the first virtual character in a world coordinate system corresponding to the virtual environment, or the character location is represented by location coordinates of the first virtual character in a local coordinate system corresponding to another virtual character.

In some embodiments, environmental perception rays are transmitted toward a plurality of directions by using the character location of the first virtual character as a starting point. The environmental perception rays are rays for detecting and measuring an object and a scene in the virtual environment. The environmental perception rays are configured for simulating operation principles of light and devices such as a sensor and a radar, to implement functions such as object detection, collision detection, and line-of-sight detection in the virtual environment. Transmission of the environmental perception rays is determined based on both a starting point and a transmitting direction. For example, the starting point is the character location, and the transmitting direction is all directions in the virtual environment.

In some embodiments, the environmental perception rays are reflected along normal directions of the environmental perception rays when the environmental perception rays collide with a surface of an obstacle. Then the computer device may obtain reflection statuses of the environmental perception rays, to generate the first-modality perception information based on the reflection statuses of the environmental perception rays. Different environmental perception rays are located at a same horizontal height.

Further, to more accurately obtain first-modality perception information of a virtual environment around the first virtual character, the computer device transmits environmental perception rays toward a plurality of directions by using at least two heights of a location of the first virtual character as starting points, and generates the first-modality perception information based on reflection statuses of the environmental perception rays. Transmitting directions of different environmental perception rays transmitted at a same height are located at a same horizontal height. For example, environmental perception rays are transmitted toward a plurality of directions by using feet, a waist, and a head at the location of the first virtual character as starting points, to obtain first-modality perception information of three different heights. Environmental perception rays respectively transmitted at a plurality of different heights are annular rays. The annular rays are several rays that are transmitted around a periphery of the first virtual character by using the first virtual character as a starting point. A plurality of annular rays obtained at a plurality of different heights may be combined and collectively referred to as a multi-layer annular ray (for example, annular rays respectively transmitted at three heights are collectively referred to as a three-layer annular ray). A limitation of a single annular ray can be avoided by using the multi-layer annular ray, to help more comprehensively represent surrounding topographic information.

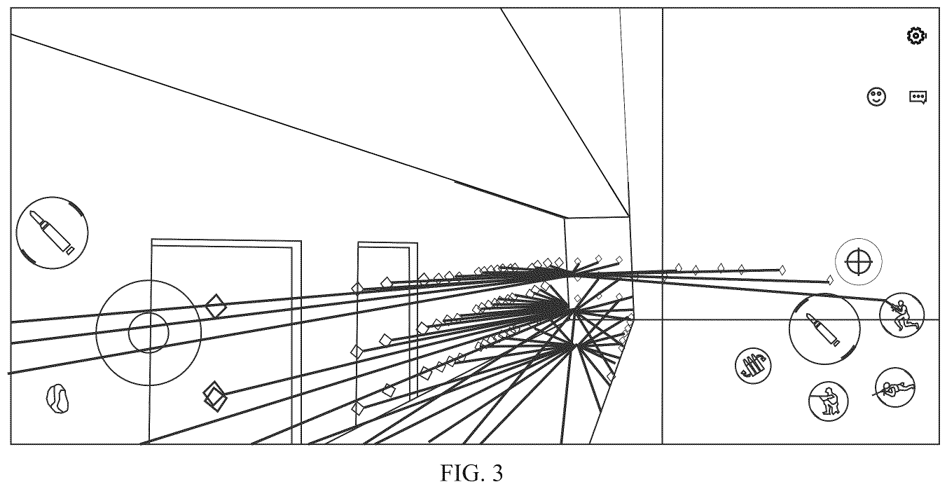

For example, FIG. 3 is a schematic diagram of a ray detection scheme according to an exemplary embodiment of this application. The computer device separately transmits environmental perception rays toward a plurality of directions by using the head, the waist, and legs of the first virtual character as starting points. The environmental perception rays are reflected when the environmental perception rays collide with an obstacle in the virtual environment, so that reflection statuses of environmental perception rays of three different heights are obtained, and the first-modality perception information is generated.

In a possible implementation, quantities of environmental perception rays transmitted by using different heights as starting points are the same. That is, quantities of annular rays at all layers are the same. Reflection statuses of annular rays of different heights can represent distances between the obstacle in the virtual environment and the first virtual character at different heights. A larger quantity of environmental rays at each layer indicates finer-grained perception of obstacles around the first virtual character and a higher requirement on performance of the computer device.

In this embodiment of this application, ray detection is performed through environmental perception rays of at least two heights, to obtain the first-modality perception information. This helps obtain environment features of a surrounding environment at different heights, to improve comprehensiveness of the environment features. In addition, the action decision-making model can be enabled to fully consider a height feature of a current virtual environment during action decision-making. This helps make a behavior presented by the first virtual character after the first virtual character executes the character action more personified, to be specific, better conform to behavioral logic of a human in a physical environment. For example, the first virtual character can be enabled to present a personified behavior such as proper stair ascending/descending, to improve vividness of the character action.
2. Obtain the second-modality perception information.

The second-modality perception information is a two-dimensional depth map in an orientation direction of the first virtual character, and the second-modality perception information is configured for representing a depth status of an obstacle in the orientation direction of the first virtual character.

In a possible implementation, the computer device obtains the second-modality perception information through ray detection based on the character location of the first virtual character in the virtual environment and an orientation of the first virtual character.

For example, the orientation is configured for representing a direction that the first virtual character faces in the virtual environment. For example, the first virtual character facing east indicates that the orientation is 0°, and the first virtual character facing south indicates that the orientation is 90°.

In some embodiments, an environmental perception ray is transmitted toward the orientation direction of the first virtual character by using the first virtual character as a starting point. The environmental perception ray is reflected along a normal direction of the environmental perception ray when the environmental perception ray collides with a surface of an obstacle, so that the computer device can generate the second-modality perception information based on a reflection status of the environmental perception ray.

For example, a single environmental perception ray is transmitted toward the orientation direction of the first virtual character by using the first virtual character as a starting point, or a plurality of environmental perception rays are transmitted toward the orientation direction of the first virtual character by using the first virtual character as a starting point.

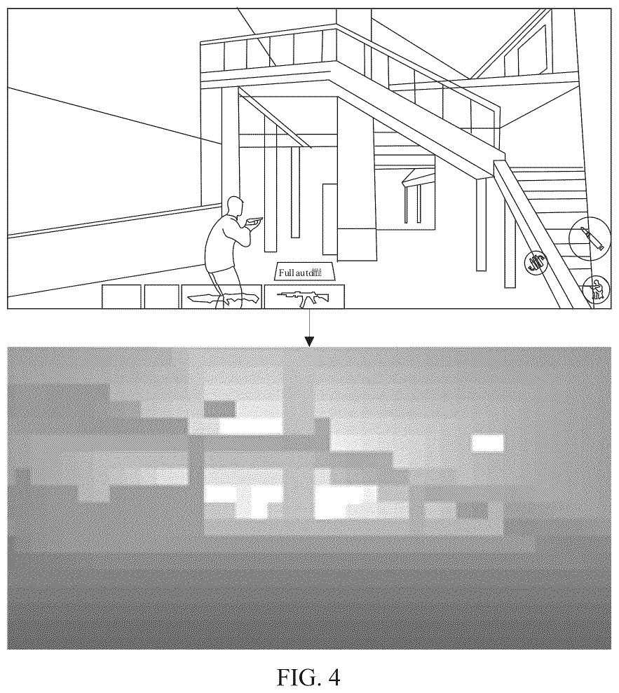

FIG. 4 is a schematic diagram of second-modality perception information according to an exemplary embodiment of this application. A schematic diagram of a virtual environment corresponds to a two-dimensional depth map. The second-modality perception information is a two-dimensional depth map in an orientation direction of a current virtual character. A darker color of a pixel in the depth map indicates a shorter distance between the first virtual character and an obstacle corresponding to the pixel. A lighter color of a pixel in the depth map indicates a longer distance between the first virtual character and an obstacle corresponding to the pixel.

Fineness of a virtual environment represented by the two-dimensional depth map is positively correlated with a resolution. A larger sampling resolution of the two-dimensional depth map indicates finer-grained depth information, represented by the two-dimensional depth map, of an obstacle in front of the first virtual character.

In this embodiment of this application, when an environmental perception ray has a reflection characteristic, an environmental perception ray is transmitted toward the orientation direction to obtain a depth map in the orientation direction of the first virtual character as the second-modality perception information. This helps improve an environmental perception capability of the first virtual character in the orientation direction, and therefore helps significantly enhance advantages in scene understanding, object detection, visual effect, and the like based on the second-modality perception information, to achieve more accurate environmental perception effect such as distance perception and environment mapping, and fully improve accuracy of an environment feature within a field of view in front of the first virtual character. In this way, a three-dimensional directional environment feature can be provided.
3. Obtain the third-modality perception information.

The third-modality perception information is a three-dimensional occupancy grid map, and the third-modality perception information is configured for representing a spatial distribution status of obstacles within a preset range. The occupancy grid map is a distribution grid map configured for describing an obstacle distribution probability of an entire map. Virtual environment space is divided into a plurality of grids by using a preset occupancy grid. The occupancy grid includes a plurality of cubes. The plurality of cubes are in a one-to-one correspondence with the plurality of grids. The grid may be understood as a partial virtual environment obtained through division. A proportion of occupancy by an obstacle in each grid is detected. All grids form a network, and the network is essentially an occupancy grid map. Each pixel in the map represents a probability distribution of an obstacle existing in an actual environment.

In a large-scale three-dimensional virtual environment, an occupancy grid has a macro perception capability for the virtual environment. In some embodiments, the computer device obtains the third-modality perception information of the virtual environment within a preset range of the first virtual character through ray detection based on the location of the first virtual character in the virtual environment. The preset range is a range that is preset based on the character location of the first virtual character. In some embodiments, the preset range is a circular area within 1 meter around the first virtual character, or the preset range is a rectangular area within 5 meters around the first virtual character.

In some embodiments, first, the virtual environment within the preset range of the first virtual character is divided by using an occupancy grid, the occupancy grid including a plurality of cubes with a same volume. Then environmental perception rays are transmitted from starting points of at least two directions in the virtual environment to the occupancy grid, so that the computer device determines a proportion of occupancy by an obstacle in each grid based on reflection statuses of the environmental perception rays, and then generates an occupancy grid map.

A macro virtual environment feature around the first virtual character may be further refined by using the occupancy grid map. For a virtual environment within a same range, a larger quantity of grids obtained through division indicates more details of virtual environment information represented by the occupancy grid map. In addition, a larger quantity of environmental perception rays transmitted toward each grid indicates more details of virtual environment information represented by the occupancy grid map.

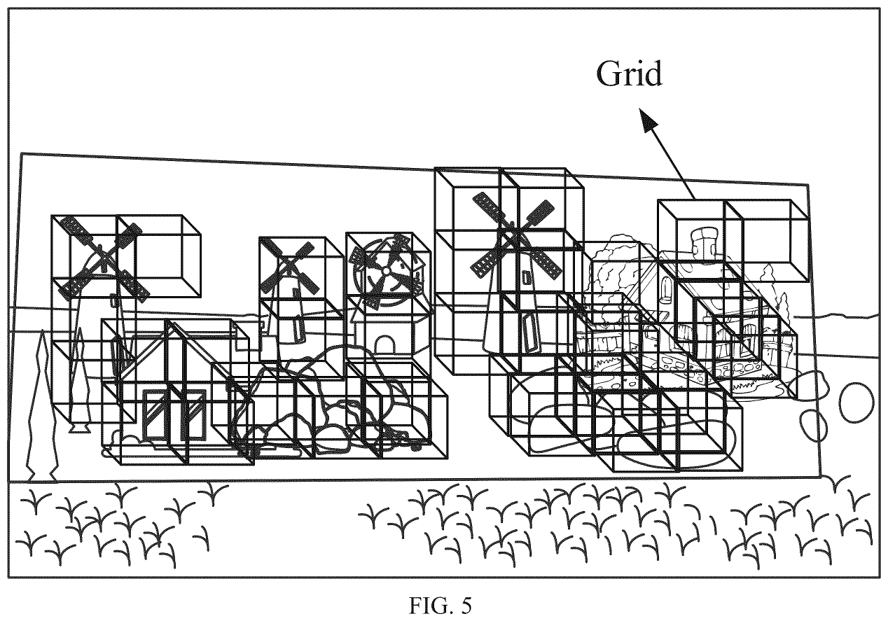

FIG. 5 is a schematic diagram of a structure of an occupancy grid according to an exemplary embodiment of this application. Volumes of cubes corresponding to different grids are consistent.

In this embodiment of this application, the virtual environment is divided by using a preset occupancy grid, and a plurality of grids obtained through division constitute an occupancy grid map used as the third-modality perception information. This makes full use of simple and intuitive modeling advantages of the occupancy grid map, and a macro environment feature around the first virtual character can be better represented. A data result of the occupancy grid map is usually implemented in a form of a three-dimensional array. Therefore, effect of accessing and analyzing the occupancy grid map is better, and the third-modality perception information can be obtained not only in advance, but also in real time. In addition, the macro environment feature may be further refined by controlling fineness of the occupancy grid, to represent a more detailed obstacle distribution.

The foregoing describes manners of obtaining first-modality environment information, second-modality environment information, and third-modality environment information. Although obtaining of environment information of different modalities relies on the character location of the first virtual character in the virtual environment, due to a dimension difference obtained during ray detection, the virtual environment can be more comprehensively analyzed in one-dimensional, two-dimensional, and three-dimensional cases. This improves comprehensiveness of obtaining of environmental perception information, and helps improve a character perception capability in the virtual environment and enhance interaction effect in the virtual environment.

In an embodiment, the action decision-making method for a virtual character is performed by an action decision-making model. The action decision-making model includes a coding network and a decision-making network. The coding network is configured to perform feature coding and fusion on character status information and environmental perception information, and the decision-making network is configured to determine a character action based on a fusion feature. In addition, the coding network includes a perception information coder and a status information coder. The decision-making network includes n action output heads. The n action output heads are configured to serially output n object sub-actions. Different action output heads correspond to different action types, and the n action output heads are serially connected based on a dependency relationship between the action types. The dependency relationship is configured for representing a dependency limitation status between sub-actions of different action types. The n object sub-actions constitute the character action.

In the action decision-making model, the n action output heads belong to an output layer of the action decision-making model, and are configured to predict actions in different dimensions, to output action parameters of different dimensions. Action dimensions of execution supported by the first virtual character may include a moving status dimension, a moving direction dimension, an orientation dimension, an attack dimension, a posture dimension, and the like. In the action decision-making model, the n action output heads respectively correspond to n action dimensions. In this case, the n action output heads output action parameters of n different dimensions. For example, an action parameter outputted by an action output head corresponding to the moving direction dimension is a moving direction, for example, a 90° direction; an action parameter outputted by an action output head corresponding to the orientation dimension is a turning angle that can represent a direction, for example, −5°, which represents rotation by 5° in a counterclockwise direction; and an action parameter outputted by an action output head corresponding to the attack dimension is attacking or no attacking. Action dimension division and action parameters outputted by action output heads corresponding to different action dimensions are not limited in this embodiment.

A process of generating a character action by using an action decision-making model is described below by using an exemplary embodiment.

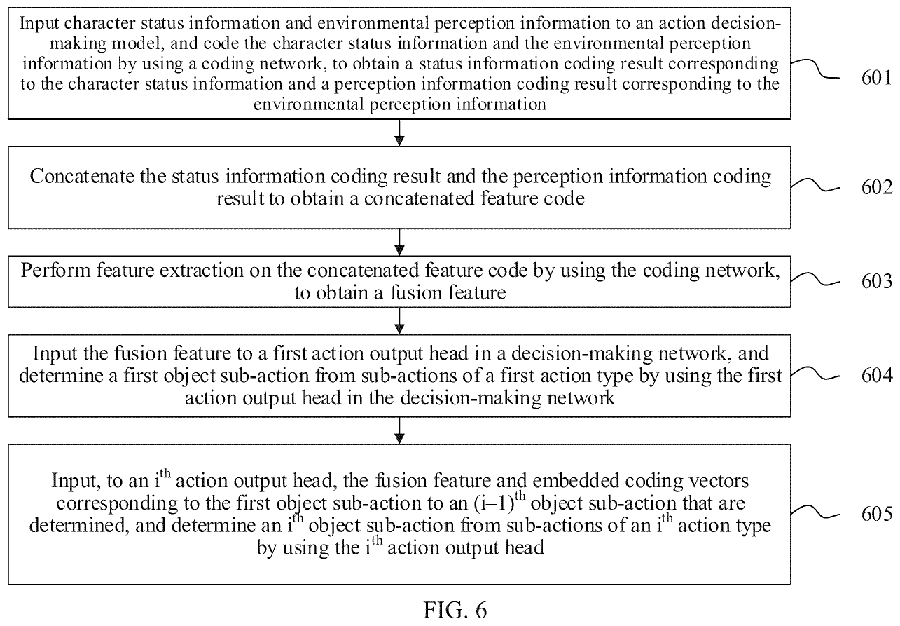

FIG. 6 is a flowchart of a process of generating a character action according to an exemplary embodiment of this application.

Operation 601: Input character status information and environmental perception information to an action decision-making model, and code the character status information and the environmental perception information by using a coding network, to obtain a status information coding result corresponding to the character status information and a perception information coding result corresponding to the environmental perception information.

In some embodiments, the character status information is coded by using a status information coder to obtain the status information coding result, and the environmental perception information is coded by using a perception information coder to obtain the perception information coding result. The two coding processes may be sequentially performed (for example, coding is first performed by using the status information coder, and then coding is performed by using the perception information coder; or coding is first performed by using the perception information coder, and then coding is performed by using the status information coder), or may be simultaneously performed. This is not limited herein.

In some embodiments, the perception information coder includes convolution kernels of different dimensions, and the convolution kernels of different dimensions are configured to perform feature coding on perception information of different modalities. In some embodiments, first-modality perception information is coded by using a one-dimensional convolution kernel in the perception information coder, to obtain a first perception information coding result. To enable the action decision-making model to perceive three-dimensional virtual environment information around a first virtual character, environmental perception information of a virtual environment around the first virtual character is obtained through cyclic convolution based on a distance, represented by each environmental perception ray, between an obstacle and the first virtual character.

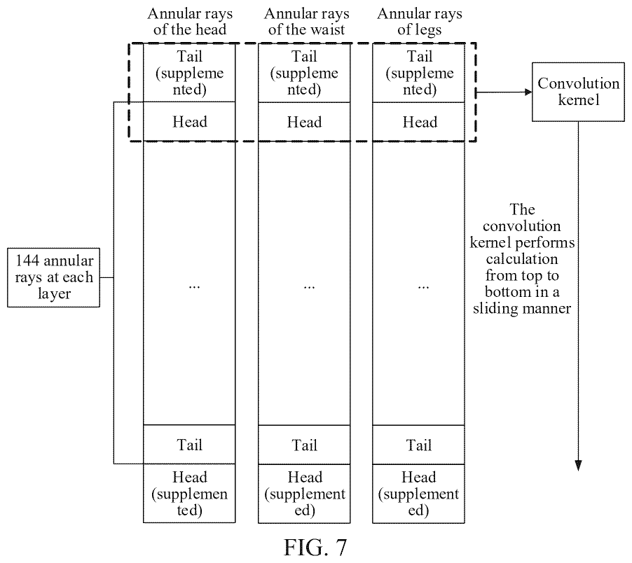

FIG. 7 is a schematic diagram of a process of performing one-dimensional convolution on environmental perception information according to an exemplary embodiment of this application. Environmental perception rays of a total of three different heights are included. Annular rays at each layer include 144 environmental perception rays. Environmental perception rays at each layer include one environmental perception ray as a head and one environmental perception ray as a tail. The annular rays are characterized by head-to-tail connection. Therefore, cyclic convolutional calculation is performed on corresponding environmental perception rays in annular rays at three layers by using the one-dimensional convolution kernel, to code the first-modality perception information.

In addition, during training of the action model, feature coding is performed on the environmental perception rays of the three different heights through one-dimensional cyclic convolution, to avoid missing information with significant value, accelerate a training process, and improve training effect.

In some embodiments, second-modality perception information is coded by using a two-dimensional convolution kernel in the perception information coder, to obtain a second perception information coding result. The two-dimensional convolution kernel is a two-dimensional matrix. In a process of coding the second-modality perception information by using the two-dimensional convolution kernel, feature coding of the second-modality perception information is completed by performing element-wise multiplication and summation on the two-dimensional matrix and an input two-dimensional depth map.

For example, processes of the element-wise multiplication and summation are described. It is assumed that there are a two-dimensional matrix A and a two-dimensional depth map with a same size. The following operations are performed on elements at same locations in the matrix A and the depth map:
(1) Element-wise multiplication:

In the element-wise multiplication, elements at corresponding element locations are multiplied to obtain a new matrix C. Each element in the matrix C is a product of elements at corresponding locations in the matrix A and the depth map.
(2) Summation:

All elements in the matrix C are added up to obtain a scalar result S, which represents a sum of all products, to be specific, a calculation result of the element-wise multiplication and the summation.

In some embodiments, third-modality perception information is coded by using a three-dimensional convolution kernel in the perception information coder, to obtain a third perception information coding result. The first perception information coding result, the second perception information coding result, and the third perception information coding result constitute the perception information coding result. Feature extraction may be performed on an occupancy grid map by using the three-dimensional convolution kernel, to provide macro three-dimensional scene perception information for a decision-making network in the action decision-making model. For example, the first virtual character has a preset task in a game scene, and to complete the preset task, the first virtual character needs to move in a map of a large range. In this case, to train an action decision-making model for this scene, the third-modality perception information is coded by using the three-dimensional convolution kernel, to help provide macro scene perception information for the action decision-making model.

The foregoing content describes a process of coding perception information of different modalities by using convolution kernels of different dimensions to obtain corresponding perception information coding results. Setting convolution kernels of different dimensions helps differentially analyze perception information of different modalities, and also helps uniquely analyze perception information of modalities in a same dimension in a targeted manner, to better retain and utilize a feature of each modality. Perception information of a plurality of modalities is coded by using different convolution kernels, to effectively integrate the perception information. In this way, the environmental perception information can express a stronger overall perception capability and environmental understanding capability, to avoid unreliability caused by adverse conditions such as noise and occlusion in a single modality, and help obtain accurate and adaptable environmental perception information in a complex virtual environment.

Operation 602: Concatenate the status information coding result and the perception information coding result to obtain a concatenated feature code.

After the status information coding result, the first environmental perception information coding result, the second environmental perception information coding result, and the third environmental perception information coding result are obtained, feature concatenation is performed on the status information coding result and the perception information coding result through a fully connected layer and an activation function, to obtain the concatenated feature code.

For example, a feature concatenation process is performed according to a concatenation sequence of the status information coding result, the first environmental perception information coding result, the second environmental perception information coding result, and the third environmental perception information coding result, to obtain the concatenated feature code; or a feature concatenation process is performed according to a concatenation sequence of the first environmental perception information coding result, the second environmental perception information coding result, the third environmental perception information coding result, and the status information coding result. The concatenation sequence is not limited herein. The fully connected layer is configured to map a feature space obtained through convolutional calculation of a previous layer to a sample label space (that is, feature representations are integrated into one value). This can reduce impact of a feature location on a classification result, and improve robustness of the action decision-making model. The activation function is configured to add a nonlinear factor, to improve an expression capability of the action decision-making model.

Operation 603: Perform feature extraction on the concatenated feature code by using the coding network, to obtain a fusion feature.

In a possible implementation, the coding network further includes an LSTM network. Feature extraction is performed by inputting the fusion feature to the LSTM network, to obtain the fusion feature. During feature extraction, the LSTM network retains a feature with more significant value and forgets a feature with low value, to implement feature extraction.

In some embodiments, the LSTM network may be replaced with another convolutional neural network. This is not limited in this embodiment.

Content of obtaining the fusion feature by using the coding network in the action decision-making model is described in operation 601 to operation 603. The character status information and the environmental perception information are respectively coded by using the status information coder and the perception information coder in the coding network. This helps capture various types of perception information in the virtual environment in a more targeted manner based on targeted analysis characteristics of different coders while improving accuracy of the character status information and refining an analysis granularity of a character status, to well implement resource management and task allocation, and obtain a more accurate fusion feature in a more efficient manner.

Operation 604: Input the fusion feature to a first action output head in the decision-making network, and determine a first object sub-action from sub-actions of a first action type by using the first action output head in the decision-making network.

Inputting the fusion feature to the decision-making network is inputting the fusion feature to the first action output head in the decision-making network and determining the first object sub-action from the sub-actions of the first action type by using the first action output head of the decision-making network.

In some embodiments, orthogonal decomposition is performed on an executable action of the first virtual character to obtain n action types, different action types include at least two executable actions, and sub-actions of different action types may be controlled independently, to be specific, the first virtual character may be controlled to execute only a sub-action of one action type. The orthogonal decomposition is configured for dividing the executable action of the first virtual character into a plurality of discrete action types. The n action types obtained through orthogonal decomposition are orthogonal action types with respect to each other. Sub-actions of different orthogonal action types have no intersection set. To be specific, one sub-action does not belong to two action types. Different orthogonal action types support simultaneous execution, and different sub-actions of a same orthogonal action type do not support simultaneous execution.

In the game scene, there is a most fundamental and finest-grained atomic action for controlling the first virtual character, and this type of action cannot be further divided or refined. A sub-action of an action type is an atomic action. Different sub-actions of a same action type cannot be simultaneously executed. For example, if the executable action of the first virtual character includes an action of crawling forward, the action may be divided into two atomic actions: crawling and moving forward. The crawling corresponds to a posture action type, and the moving forward corresponds to a moving direction action type. For another example, if the executable action of the first virtual character includes an action of in-situ peeking and shooting, the action may be divided into three atomic actions: staying in situ, peeking, and shooting. The staying in situ corresponds to a moving status action type, the peeking corresponds to a peeking action type, and the shooting corresponds to an attack action type.

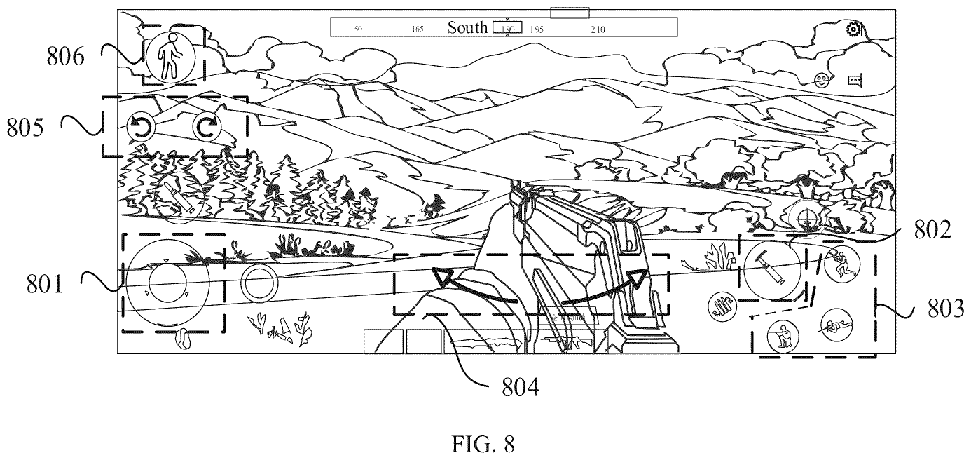

For example, FIG. 8 is a schematic diagram of a user interface of an application for providing a virtual environment according an exemplary embodiment of this application. A moving status control 801, an attack control 802, a posture adjustment control 803, a horizontal turning control, a vertical turning control 804, a left-right peeking control 805, and a moving status control 806 are included. Different controls may trigger to control a virtual character to execute different actions.

Orthogonal decomposition is performed on actions corresponding to the controls shown in the foregoing figure, to obtain a plurality of action types. In some embodiments, there may be a dependency relationship between different action types. For example, standing or leaning is performed only when an attack needs to be performed. In this case, posture action decision-making of a character action needs to rely on action decision-making of the attack action type. In addition, the dependency limitation status indicates that a dependency limitation relationship may exist between sub-actions of different action types. For example, if an attack action cannot be simultaneously executed when the first virtual character executes a sprinting action, a dependency limitation relationship exists between the sprinting action and the attack action. Therefore, to enable the action decision-making model to consider a dependency relationship between different actions and a dependency limitation status between different sub-actions of different action types during action decision-making, the n action output heads in the decision-making network are serially connected based on the dependency relationship between the action types.

In some embodiments, during determining of a connection sequence of different action output heads, sorting is performed based on degrees of association of different action types with a task to be completed by the first virtual character. For example, if the task of the first virtual character is to defeat an enemy, it can be determined that a degree of association of the attack action type is high, and an action output head corresponding to the attack action type is arranged at a front location; and a degree of association of a leaning action type is clearly low, and an action output head corresponding to the leaning action type is arranged at the last location.

For example, Table 2 shows a correspondence between an action output head and an action type after orthogonal decomposition according to an exemplary embodiment of this application.

TABLE 2

| | Action dimension | |
|---|---|---|
| | (a quantity | |
| Action output | of included | |
| head name | sub-actions) | Action type |
| Yaw_to_focus | 7 | Coarse-grained horizontal |
| | | orientation |
| bFire | 2 | Whether an attack is initiated |
| Yaw_to_aim | 21 | Fine-grained horizontal |
| | | orientation |
| Pitch_to_aim | 15 | Fine-grained vertical |
| | | orientation |
| Move_type | 4 | Moving mode |
| Yaw_to_move | 8 | Moving direction |
| Posture_type | 4 | Standing |
| Lean_type | 3 | Whether leaning is performed |

In some embodiments, when the first virtual character needs to aim at another virtual character and the another virtual character may serve as an opponent of the first virtual character, that is, when the first virtual character needs to aim at an opponent, if a turning design scheme of even distribution within a turning range is used, it is difficult for the first virtual character to quickly and precisely aim at an enemy when a turning granularity is excessively large or excessively small. Therefore, precise aiming may be implemented by combining a coarse-grained turning angle and a fine-grained turning angle. An angle interval corresponding to a sub-action of the coarse-grained turning angle is a first interval. An angle interval corresponding to a sub-action of the fine-grained turning angle is a second interval. A product of the first interval and an action dimension of the coarse-grained horizontal orientation is a current field of view of the first virtual character. The current field of view changes with the moving direction of the first virtual character. A product of the second interval and the action dimension is equal to a first action interval.

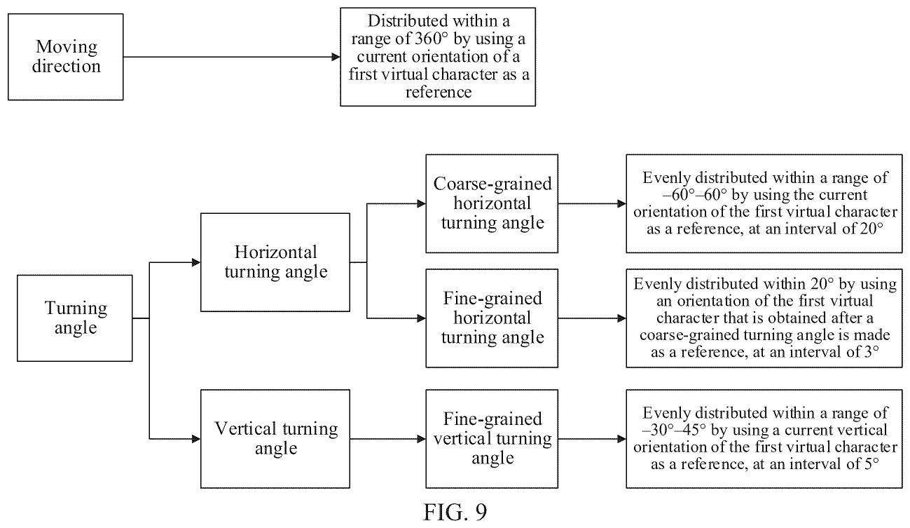

FIG. 9 is a schematic diagram of a moving direction and a description of sub-action composition of an action according to an exemplary embodiment of this application. A moving direction action type is divided into eight different angles, and are distributed within a range of 360° by using a center area of a current orientation of the first virtual character as a reference. A turning angle includes a horizontal turning angle and a vertical turning angle. The horizontal turning angle includes a coarse-grained horizontal turning angle and a fine-grained horizontal turning angle. The coarse-grained horizontal turning angle uses the current orientation of the first virtual character as a reference, the current orientation is set to 0°, a turning range is 120°, and an interval between sub-actions of a coarse-grained turning angle is 20°. To be specific, turning angles that correspond to sub-actions and that are included in the coarse-grained turning angle are 0°, 20°, 40°, 60°, −20°, −40°, and −60°. Therefore, when it is determined that an object sub-action of the coarse-grained turning angle corresponds to 40°, a coarse-grained horizontal orientation of the first virtual character is 40° after the turning action is executed. A fine-grained turning angle uses an estimated orientation of the first virtual character after the first virtual character pre-executes a coarse-grained sub-action as a reference, that is, is 0°, and is evenly distributed within a specified range. The specified range may be 20. In addition, an interval between sub-actions of the fine-grained turning angle may be 3°. Therefore, turning angles that correspond to sub-actions and that are included in the fine-grained turning angle are 3°, 6°, 9°, . . . , and 21°. Therefore, it is determined that an object sub-action of the fine-grained turning angle corresponds to turning rightward by 6°. An orientation range in a vertical direction is small. Therefore, division of sub-actions may be performed by using a fine-grained turning angle. A current orientation of the virtual character is used as a reference, that is, 0°. A specified range is −30°-45°, and an interval between sub-actions may be set to 3°.

In some embodiments, a clockwise turning angle is a positive value, a counterclockwise turning angle is a negative value, an upward turning angle is a positive value, and a downward turning angle is a negative value, or vice versa. This is not limited in this embodiment.

Operation 605: Input, to an i^{th} action output head, the fusion feature and embedded coding vectors corresponding to the first object sub-action to an (i−1)^{th} object sub-action that are determined, and determine an i^{th} object sub-action from sub-actions of an i^{th} action type by using the i^{th} action output head.

n is a positive integer greater than 2. i is a positive integer greater than 1.

The n action output heads are connected through an autoregressive embedding layer. Because there is a dependency relationship between different action types, after a previous output head determines an object sub-action, at least one determined object sub-action and a fusion vector are to be inputted to a next action output head based on the autoregressive embedding layer, so that the next action output head determines an object sub-action based on the dependency relationship.

Autoregression is a method of processing a time sequence in statistics. Performance of a variable at a current moment is predicted by using previous moments of a same variable. The autoregression has time sequence autocorrelation. The essence of embedding is data compression, to represent a high-dimension feature with redundant information by using a low-dimension feature.

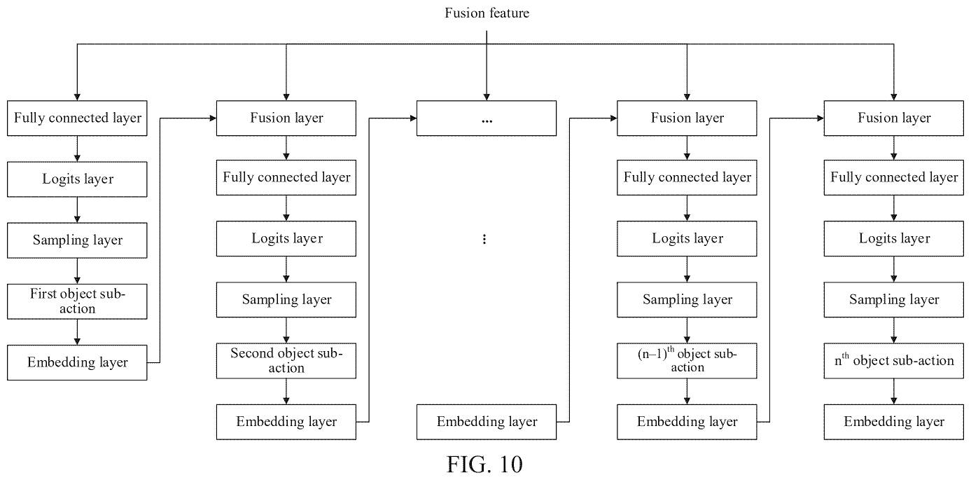

FIG. 10 is a schematic diagram of an autoregressive structure of n action output heads according to an exemplary embodiment of this application. An action output head includes a fully connected layer, a logits layer, a sampling layer, and an embedding layer. The logits layer determines an object sub-action based on an execution probability distribution between sub-actions of a determined action type. After the object sub-action is determined, the embedding layer transmits the determined sub-action to a next serially connected action output head, and a fusion layer in the action output head fuses previously determined object sub-actions, to determine a new object sub-action based on the determined object sub-action. In addition, the coding network also inputs the fusion feature to each action output head.

In this embodiment of this application, environmental perception information of different modalities (namely, different information dimensions) is coded based on convolution kernels of different dimensions, so that environment information of different information dimensions can be processed by using an appropriate coding scheme, to improve a feature expression of coded environmental perception information, and enable the action decision-making model to obtain a more accurate environment feature.

In this embodiment of this application, content of performing action decision-making by using the decision-making network in the action decision-making model is further described. The first object sub-action may be determined from sub-actions of an action type by using an action output head in the decision-making network. A manner of integrating the embedded coding vectors of the first i−1 object sub-actions and the fusion feature to the i^{th} action output head helps more comprehensively determine the i^{th} object sub-action. This structure helps a system perform efficient decision-making and action planning in a complex environment. Fused multimodal information is used to guide selection of each action, and a previous decision-making result is transmitted by using an embedded coding vector, to ensure continuity and appropriateness of a subsequent action.

A dependency limitation relationship exists between sub-actions of different action types, and at least two sub-actions that have a dependency limitation relationship cannot be simultaneously executed. Therefore, if a previously determined object sub-action exists, a dependency limitation relationship may exist between some sub-actions of a subsequent action type and the determined object sub-action. In addition, a dimension of an action space obtained through orthogonal decomposition is still very high, leading to explosion of abundant personified atomic action space combinations. Therefore, sub-actions may be determined based on appropriateness (namely, a dependency limitation relationship) of a combination of different sub-actions, to improve personification of an action combination. In addition, during training of the action decision-making model, ineffective decision-making policy exploration performed by the decision-making network may be reduced through action masking, to improve personification of action decision-making performed by the action decision-making model while enhancing training efficiency.

The action masking may be used for an RL model (corresponding to the action decision-making model in this embodiment of this application), and may mask an inappropriate or invalid sub-action set in a large-scale decision space, to reduce meaningless action exploration, and enable the decision-making network to converge more rapidly. Essentially, the action masking is configured for blocking sub-actions of different action types that are inappropriate and that have a dependency limitation relationship with a determined object sub-action. Through action masking, a probability of a to-be-masked sub-action in a probability distribution obtained by an action output head is reduced. Therefore, when sampling is performed based on the probability to determine an object sub-action, it is difficult to determine a masked sub-action as an object sub-action. Through action masking, a sub-action branch that does not need to be explored can be directly excluded during action decision-making, to reduce an action space, and ensure strength of the action decision-making model while enhancing exploration efficiency of the action decision-making model.

At least two sub-actions that have a dependency limitation relationship belong to different action types, and at least two sub-actions that have a dependency limitation relationship cannot be simultaneously executed. In some embodiments, a dependency limitation relationship exists between a first sub-action and a second sub-action. In this case, the two sub-actions cannot be simultaneously executed, and action masking is performed on the second sub-action when it is determined that the first sub-action is a character action. In some embodiments, a dependency limitation relationship exists between a fourth sub-action and a combination of a second sub-action and a third sub-action. In this case, the fourth sub-action and the combination of the second sub-action and the third sub-action cannot be simultaneously executed, and action masking is performed on the fourth sub-action when it is determined that both the second sub-action and the third sub-action are object sub-actions.

In some embodiments, the action decision-making model includes an action masking network. The action masking network is connected to the n action output heads in the decision-making network, and is configured to perform action masking on sub-actions of each action type when each output head performs action decision-making.

In some embodiments, before determining the character action, the computer device performs, based on the first object sub-action to the (i−1)^{th} object sub-action that are determined and the dependency limitation status between different sub-actions of different action types, action masking on the sub-action of the i^{th} action type corresponding to the i^{th} action output head; and then determines the i^{th} object sub-action from unmasked sub-actions of the i^{th} action type by using the i^{th} action output head.

In some embodiments, during action masking, at a raw logits action output layer of a network, a negative number with a very large absolute value is added to logits of an inappropriate sub-action, to ensure that a logits value corresponding to the action is less than logits values of all appropriate sub-actions. In this way, a logits distribution of the action output layer is reshaped, and a probability that an inappropriate action is sampled is mapped to be close to zero.

The foregoing content describes that the decision-making network optimizes a sub-action selection process through action masking and dependency limitation during decision-making. Through action masking, inappropriate or ineffective sub-action selection can be excluded based on a dependency relationship and a limitation between sub-actions of different action types. This helps ensure that selected sub-actions are logically consecutive and effective, and can also avoid conflicting and inconsistent action selection, to ensure appropriateness of an entire action. Efficient action selection means that an appropriate action can be executed more quickly and effectively, to save resources and optimize an overall execution process.

Before action masking is performed, first, a to-be-masked sub-action that has a dependency limitation relationship with a determined object sub-action is determined, based on the determined object sub-action, from an action type on which decision-making is to be performed. Specifically, the following three cases may be included.
1. One determined object sub-action has a dependency limitation relationship with a to-be-masked sub-action of an action type on which decision-making is to be performed.

In a possible implementation, if a determined j^{th} object sub-action exists and a dependency limitation status indicates that a dependency limitation relationship exists between the j^{th} object sub-action and at least one first sub-action of an i^{th} action type, action masking is performed on the first sub-action of the i^{th} action type, j being less than i (to be specific, a j^{th} action head is serially connected before an i^{th} action head).

For example, if a determined sprinting action exists and a dependency limitation status indicates that a dependency limitation relationship exists between the sprinting action and a squatting action, when a posture action type of the first virtual character is determined, action masking is performed on the squatting action of the posture action type, j being a positive integer greater than 2.

In some embodiments, the computer device may perform one-hot processing on an object sub-action determined by a previous action output head, and then perform matrix multiplication on a one-hot matrix corresponding to a previous object sub-action based on a limitation matrix configured for representing a dependency limitation relationship between sub-actions of a next action type and sub-actions of a previous action type, to obtain an action masking matrix corresponding to the next action type. For example, the computer device transmits, based on the action masking matrix, an action determined by the previous action output head to a next action output head.

For example, an action type a1 is attack initiation (including attacking and no attacking), an action type a2 is a virtual character posture (including squatting, jumping, crawling, and standing), and an action type a7 is a moving status (including silent steps, quick walking, sprinting, and staying in situ) of a virtual character. The action type a1 corresponds to an action output head H1, the action type a2 corresponds to an action output head H2, and the action type a7 corresponds to an action output head H7. A dependency limitation relationship exists between attacking and sprinting, and a dependency limitation relationship also exists between squatting and sprinting. Because values of sub-actions flow in a form of a tensor in a neural network, gradient discontinuity cannot be avoided by directly sampling an object sub-action.

Therefore, samples are first determined as a one-hot matrix τ_{n×m}. It is assumed that n=3 samples exist, an action dimension m (to be specific, a quantity of included sub-actions) of a1 is 2, and obtained output object sub-actions of the action output head H1 of the three samples are {attacking, no attacking, attacking}. In this case, the n×m one-hot matrix τ_{n×m} corresponding to the three samples is as follows:

$${τ}_{n \times m} = {[ \begin{matrix}0 & 1 \\ 1 & 0 \\ 0 & 1\end{matrix} ]}_{3 \times 2}$$

τ_{n×m} is a one-hot matrix outputted by the action output head H1 in the samples, a quantity of rows is a quantity n of samples, and a quantity of columns represents a quantity m of sub-actions included in the action type a2.

Then an auxiliary mapping matrix M is constructed. To be specific, a mapping matrix that can represent a dependency limitation relationship between a sub-action of the action type a1 and a sub-action of the action type a7 is constructed. Because a mapping relationship for the action type a7 is constructed through sampling only based on an object sub-action outputted by the single action output head H1, a one-hot matrix including all different actions of the action output head H1 is initially an m×m identity matrix, the first row is mapped to an object sub-action “attacking”, and the second row is mapped to an object sub-action “no attacking”.

$$E = {[ \begin{matrix}1 & 0 \\ 0 & 1\end{matrix} ]}_{2 \times 2}$$

Because a dimension P corresponding to the action output head H7 is 4, to indicate that sprinting is not simultaneously performed when attacking is performed, an auxiliary mapping matrix M_{m×p} may be obtained as follows:

$$M = E \times = {[ \begin{matrix}1 & 1 & 1 & 1 \\ 1 & 1 & 1 & 0\end{matrix} ]}_{2 \times 4}$$

The matrix M_{m×p} is essentially a mapping from H1 to H7. A quantity of rows represents the dimension m of the previous action head H1, and a quantity of columns represents the dimension P of the next affected action head H7. Each row is correspondingly associated with each row in the identity matrix E_{m×m}. A specific value of each row is impact of each sub-action in the previous action output head H1 on the next action output head H7.

Finally, matrix multiplication is performed to map, to the action output head H7, impact of being unable to perform sprinting when an attack is initiated in τ_{n×m} in the samples, to obtain an action masking matrix X₇ corresponding to the action output head H7

$${X}_{7} = {[ \begin{matrix}0 & 1 \\ 1 & 0 \\ 0 & 1\end{matrix} ]}_{3 \times 2} \times {[ \begin{matrix}1 & 1 & 1 & 1 \\ 1 & 1 & 0 & 1\end{matrix} ]}_{2 \times 4} = {[ \begin{matrix}1 & 1 & 0 & 1 \\ 1 & 1 & 1 & 1 \\ 1 & 1 & 0 & 1\end{matrix} ]}_{3 \times 4}$$

The action masking matrix X₇ is configured for representing impact of an object sub-action outputted by the previous action output head H1 on a sub-action of an action type corresponding to the next action output head H7 in all samples. A size of X₇ is related only to a quantity of samples and the dimension of the action output head H7. A quantity of rows represents that three samples are sampled, and a quantity of columns represents different sub-actions of the action type a7. In the foregoing process, corresponding sprinting sub-actions in all samples are masked when a determined object sub-action is attacking, and then probability distribution conversion is performed on a probability distribution, determined by the action output head H7, of sub-actions of the action type a7, to ensure that the action output head H7 does not sample a sprinting action.

Similarly, for the action type a2, an action masking matrix Y₇, obtained through the foregoing processing, of an object sub-action of the action type a2 with respect to the action type a3 is also used. Because both the action type a1 and the action type a2 independently affect the action type a7, the action output head H7 superposes impact of object sub-actions of previous action outputs on sub-actions of the action type a7, to obtain an action masking matrix L₇ corresponding to the action output head H7:

$${L}_{7} = {X}_{7} ○ {Y}_{7}$$

The matrix L₇ is a Hadamard product of X₇ and Y₇. Sub-actions of the action type a7 to which all elements with values being 0 in L₇ are masked.

In the foregoing manner, impact of a previously determined object sub-action on a sub-action of an action type corresponding to a next action output head may be mapped to an action masking matrix, to sequentially transmit the impact backward among the n action output heads. During training of the action decision-making model, this can effectively resolve a problem that the decision-making model performs massive ineffective exploration in a high-dimensional action space.
2. A combination of at least two determined object sub-actions has a dependency limitation relationship the combined with a to-be-masked sub-action of an action type on which decision-making is to be performed.

In another possible implementation, determined object sub-actions may exist. The two object sub-actions do not independently affect a sub-action of a next action type. After at least two determined object sub-actions are combined, the combination has a dependency limitation relationship with a sub-action of an action type on which decision-making is to be performed. For example, two action types exist: a moving direction and a horizontal turning angle. None of sub-actions of the two action types independently affects a sprinting action of a to-be-determined action type. However, when a difference between a horizontal turning angle and a moving direction in a determined object sub-action is large (180° in an extreme case), for example, when a gazing direction of the first virtual character is 0° but a moving direction is a direction of 180°, because backward sprinting is not supported for the first virtual character recedes in conventional settings, the first virtual character does not support simultaneous execution of the sprinting action in this case.

In this case, object sub-actions outputted by at least two action output heads are to be combined, to determine impact of a combination of at least two object sub-actions on a sub-action of an action type on which decision-making is to be performed, and the impact is mapped to an action masking matrix corresponding to the action type on which decision-making is to be performed.

In some embodiments, first, one-hot matrix coding is separately performed on the object sub-actions outputted by the at least two action output heads. Then at least two one-hot matrices are concatenated to form a combined one-hot matrix. Then logical conversion is performed on the combined one-hot matrix, to map the combined one-hot matrix to an identity matrix. Then an auxiliary mapping matrix is determined in the manner shown in the foregoing manner 1, and impact of a combination of at least two object sub-actions on an action type on which decision-making is to be performed is mapped to each row (each type of action) based on the auxiliary mapping matrix, to implement action masking on a sub-action of the action type on which decision-making is to be performed.

For example, an action type a3 is a moving direction (including eight moving directions evenly distributed within 360°), an action type a4 is a horizontal orientation (including eight orientation angles evenly distributed within 360°), and an action type a7 is a moving status (including silent steps, quick walking, sprinting, and staying in situ) of a virtual character. The action type a3 corresponds to an action output head H3, the action type a4 corresponds to an action output head H4, and the action type a7 corresponds to an action output head H7.

An action dimension corresponding to the action type a3 is s, and an action dimension corresponding to the action type a4 is h. A one-hot matrix formed by combining different sampling sub-actions of the action output head H3 is an s×s identity matrix E_{s×s}. A one-hot matrix formed by combining all different sampling actions of the action output head H4 is an h×h identity matrix E_{h×h}. A combined one-hot matrix T_{(s×h)×(s+h)} obtained by performing feature concatenation on the identity matrix E_{s×s} and the identity matrix E_{h×h} is not a square matrix. A quantity s×h of rows represents all action combinations, and a quantity s+h of columns represents a combination dimension, to be specific, a sum of a quantity of sub-actions of the action type a3 and a quantity of sub-actions of the action type a4. Then T_{(s×h)×(s+h)} is converted into an identity matrix E_{(s×h)×(s×h)} with a dimension of s×h. In this case, each row of the identity matrix represents an action combination. Then an auxiliary mapping matrix M may be determined based on a dependency limitation relationship.

In some embodiments, it is assumed that a combined one-hot matrix corresponding to object sub-actions outputted by the action output head H3 and the action output head H4 in all samples is τ_{n×(s+h)}. In this case, an action masking matrix corresponding to the action output head H7 may be determined through the following calculation:

First, a mapping of converting each row of action combinations in the samples into an approximate one-hot matrix is calculated as follows:

$${U}_{n \times ( s \times h )} = {τ}_{n \times ( s + h )} \times {X}_{( s + h ) \times ( s \times h )}$$

X_{(s+h)×(s×h)} is a generalized inverse matrix of T_{(s×h)×(s+h)}. U_{n×(s×h)} is a mapping of converting each row of action combinations in the samples into an approximate one-hot matrix. Because X_{(s+h)×(s×h)} is not a precise inverse matrix of T_{(s×h)×(s+h)}, U_{n×(s×h)} needs to be converted into a precise one-hot matrix:

$${Z}_{n \times ( s \times h )} = one - hot ( arg max ( {U}_{n \times ( s \times h )} ) )$$

Each row of Z_{n×(s×h)} represents an action combination of a sample. Each row has s×h matrix values. Only one element value is 1, and all remaining element values are 0. An element value being 1 represents that an action combination is to be associatively mapped to a corresponding row of the auxiliary mapping matrix M, to affect a matrix value of a corresponding row of the action masking matrix corresponding to the action output head H7. F_{n×p} is the action masking matrix in the action output head H7, and each row represents impact of the action type a3 and the action type a4 on a sub-action of the action type a7.

Through the foregoing calculation, action masking can be implemented when a combination of different sub-actions has a dependency limitation relationship with a sub-action of an action type on which decision-making is to be performed, to address low exploration efficiency of the decision-making network in a highly coupled and high-dimensional complex action space.
3. The character status information and the environmental perception information indicate that a status of a current virtual environment has a dependency limitation relationship with a to-be-masked sub-action of an action type on which decision-making is to be performed. That is, it is not suitable to perform the to-be-masked sub-action in the current virtual environment.

In a possible implementation, the first virtual character may have a task of attacking another virtual character, evading another virtual character, or the like. Therefore, during action decision-making, action masking may be performed, based on a visibility status of the first virtual character with respect to the another virtual character, on a sub-action of the action type on which decision-making is to be performed.

In some embodiments, an environmental perception ray is transmitted to each part of another virtual character in an orientation direction of the first virtual character by using an eye location of the first virtual character as a starting point. A visibility status of each part of the another virtual character in the virtual environment is determined based on a reflection status of the environmental perception ray, the visibility status being configured for representing whether each part of the another virtual character is blocked by a bunker. If the environmental perception ray is blocked by an obstacle, the part of the another virtual character is invisible. If the environmental perception ray is not blocked by an obstacle and collides with the another virtual character, the part of the another virtual character is visible.

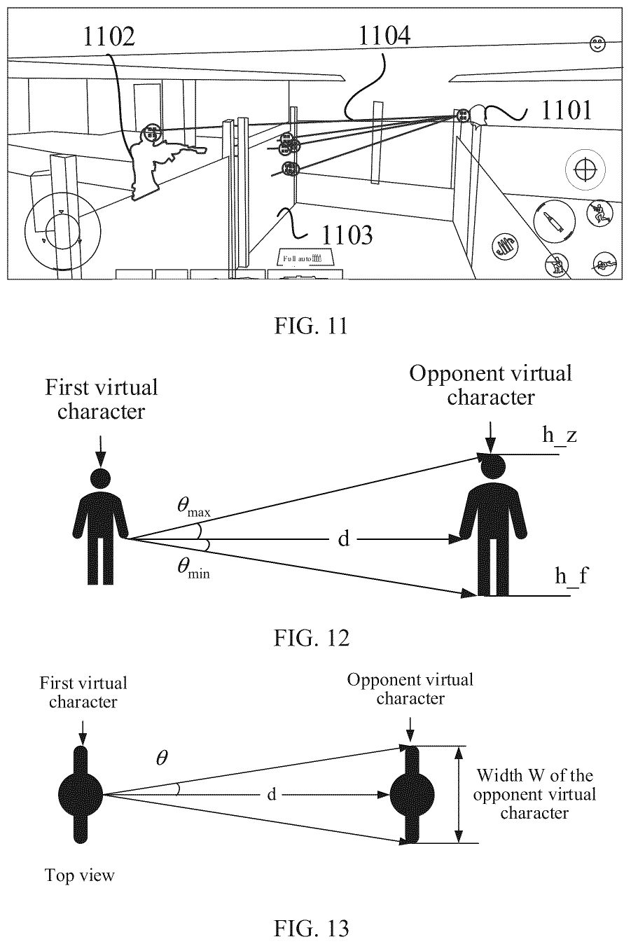

FIG. 11 is a schematic diagram of visibility status perception according to an exemplary embodiment of this application. An environmental perception ray is transmitted to each part of an opponent virtual character 1102 by using an eye of a first virtual character 1101 as a starting point. If a part of perception rays are blocked by an obstacle 1103, a body part of the opponent virtual character that corresponds to this part of rays is invisible. If a perception ray 1104 is not blocked by an obstacle and collides with the head of the opponent virtual character, the head of the opponent virtual character is visible.

The foregoing content describes a process of performing action optimization in a virtual environment based on environmental perception rays and a visibility status. Consideration of a visual obstacle and visibility in the virtual environment helps determine an action behavior of a virtual character more intelligently, so that the action behavior better conforms to behavioral logic in the real world, to improve reality and vividness of interaction of the first virtual character in the virtual environment, and enable a player to have more immersive experience. The first virtual character can further flexibly adjust a behavior of the first virtual character based on a real-time change in a surrounding environment and movement or disappearance of an obstacle, to enhance autonomy of the first virtual character in the virtual environment.

After determining the visibility status of each part of the another virtual character, the computer device performs action masking on a sub-action of a character action type based on the visibility status of each part of the another virtual character.

An object sub-action has a dependency limitation relationship with the visibility status of each part of the another virtual character. For example, when the character action type is a shooting action, if the visibility status of each part of the another virtual character indicates that the another virtual character is invisible, action masking is performed on a “shooting” sub-action in the character action, to avoid frequent shooting when the first virtual character is not aiming at an enemy.

After masking a sub-action of the character action type, the computer device determines a sub-action from unmasked sub-actions of the character action type by using a character action output head.

In another possible implementation, a serial sequence of the n action output heads is determined based on a dependency relationship between corresponding action types. Therefore, for a same action type, when fine granularities of sub-actions corresponding to two action output heads are different, an approximate action range may be first determined based on a coarse granularity, and then a fine-grained object sub-action is determined based on a determined coarse-grained object sub-action.

In a possible implementation, at least two of the n action output heads correspond to a same action type, the i^{th} action output head among the n action output heads corresponds to a coarse-grained sub-action, a j^{th} action output head among the n action output heads corresponds to a fine-grained sub-action, and i is less than j. Therefore, in a process of determining an object sub-action, the computer device first determines the i^{th} object sub-action from the coarse-grained sub-action by using the i^{th} action output head in the decision-making network, and then determines a j^{th} object sub-action from the fine-grained sub-action by using the j^{th} action output head based on a fusion vector and an embedded coding vector corresponding to the i^{th} object sub-action, an action range indicated by the j^{th} object sub-action being less than an action range indicated by an i^{th} character action.

For example, for the coarse-grained horizontal orientation and the fine-grained horizontal orientation in Table 2, during action decision-making, the coarse-grained horizontal orientation is to be determined before the fine-grained horizontal orientation.

Therefore, when the first virtual character needs to aim at another virtual character, a turning angle range within which an opponent virtual character can be aimed at may be first determined, and then action masking is performed on a turning angle, in a turning action type, at which the first virtual character cannot aim at the opponent virtual character.

FIG. 12 is a schematic diagram of determining an effective aiming range in a vertical direction according to an exemplary embodiment of this application. First, a distance d between the first virtual character and an opponent virtual character is determined based on location coordinates of the opponent virtual character and location coordinates of the first virtual character, and a height h of the opponent virtual character is obtained, where h=h_z−h_f. In this case, the opponent virtual character may be aimed at when a crosshair of a virtual item held by the first virtual character falls within a height range of the first virtual character in the vertical direction. Therefore, the following may be obtained based on a trigonometric function:

$${θ}_{max} = ac tan [ ( h\_z - h\_f ) / d ]$$

$${θ}_{min} = ac tan [ ( h\_f - h\_z ) / d ]$$

$${τ}_{pitch} = {θ}_{max} - {θ}_{min}$$

A horizontal direction is used as a current orientation direction, that is, 0°. θₘₐₓ is an effective aiming range of upward turning, and θₘᵢₙ is an effective aiming range of downward turning. In this case, a difference τ_{pitch} between the two effective aiming ranges is an effective aiming range of a vertical turning action.

For a horizontal turning action type, a coarse-grained turning action for aiming at an opponent virtual character may be roughly determined first, and then a fine-grained turning action is adjusted to aim at the opponent virtual character.

For example, a first turning action output head among the n action output heads corresponds to a coarse-grained turning action, a second turning action output head among the n action output heads corresponds to a fine-grained turning action, the first turning action output head is configured to determine a first turning angle, and the second turning action output head is configured to determine a second turning angle.

For example, the first turning angle is a turning angle in a coarse-grained form determined based on a plurality of coarse-grained turning angles, and the second turning angle is a turning angle in a fine-grained form determined based on a plurality of fine-grained turning angles.

First, the computer device determines an ideal turning angle based on an orientation of the first virtual character, location coordinates of the first virtual character, and location coordinates of the another virtual character, and determines an aiming distance between the first virtual character and the another virtual character. The computer device first calculates the aiming distance based on the location coordinates of the first virtual character and the location coordinates of the another virtual character; then determines a direction of the another virtual character relative to the first virtual character based on a trigonometric function, to determine the ideal turning angle based on a current orientation and direction of the first virtual character.

Then the computer device determines an effective aiming range based on the aiming distance and a width of the another virtual character.

For example, FIG. 13 is a schematic diagram of an effective aiming range in a horizontal direction according to an exemplary embodiment of this application. A current orientation of the first virtual character is 0°, a distance between the first virtual character and another virtual character is d, and a width of an opponent virtual character is W. In this case, it is determined that an effective aiming range is as follows:

$$θ = ac tan [ ( W / 2 ) / d ]$$

$${τ}_{pitch} = 2 θ$$

θ is an effective turning range of clockwise and counterclockwise turning angles of the first virtual character. An effective clockwise turning range is combined with an effective counterclockwise turning range, to obtain an effective aiming range τ_{pitch}.

After the ideal turning angle is determined, a difference between the first turning angle and the ideal turning angle is first determined based on the first turning angle determined by the first turning action output head. The difference may be a positive value or a negative value. The positive value indicates that an estimated orientation of the first virtual character is in a clockwise direction of the another virtual character after the first turning angle is made. The negative value indicates that an estimated orientation of the first virtual character is in a counterclockwise direction of the another virtual character after the first turning angle is made.

In some embodiments, the computer device determines an effective coarse-grained turning angle based on the ideal turning angle; performs action masking on a turning angle, in the coarse-grained turning action of the virtual character, that does not belong to the effective coarse-grained turning angle; and then determines the first turning angle from unmasked sub-actions. Then the computer device determines an effective fine-grained turning angle based on the angle difference and the effective aiming range. The determined effective fine-grained turning angle enables an orientation of the first virtual character to be within the effective aiming range after the first virtual character executes a turning action based on the fine-grained turning angle in a current orientation. Then action masking is performed on a turning angle, in the coarse-grained turning action, that does not belong to the effective fine-grained turning angle, and the second turning angle is determined from unmasked effective fine-grained turning angles in the fine-grained turning action by using the second turning action output head. Finally, the first virtual character can aim at the another virtual character after executing the first turning action and the second turning action.

The foregoing content describes coarse-grained and fine-grained control and optimization during turning of the first virtual character in the virtual environment. Through coarse-grained and fine-grained turning control, a turning behavior of the first virtual character can be more natural and intelligent, and is closer to a behavioral expression in the real world. Optimized turning control can improve tactical effect and a combat policy of the first virtual character in a game, and enhance immersion of game experience. Unnecessary calculation and turning operations can also be reduced by using the action masking technology, to improve action execution efficiency and performance. Precise control of a turning angle can enable the first virtual character to more precisely execute various actions and interactions, to enhance action operation precision and controllability.

The foregoing content describes a function of the decision-making network in multi-layer action selection, including coarse-grained and fine-grained sub-action selection processes. The multi-layer action selection helps provide coarse-grained and fine-grained guidance for execution of each action, to improve overall action execution precision and efficiency. By gradually narrowing an action range, action selection and execution modes may be adjusted and optimized based on a change in the virtual environment and a task requirement, to improve adaptability and flexibility of determining of an object sub-action. Each action selection is based on a result of a previous operation and a detailed action description, to reduce a decision-making error caused by incomplete information or misunderstanding, and improve reliability and stability of determining of an object sub-action.

In a possible implementation, to avoid frequent execution of a character action, which does not conform to behavioral logic of humans, cooldown time may be set for some sub-actions, and action masking is performed on a sub-action when cooldown of the sub-action has not been completed. This prevents the first virtual character from repeatedly executing a same action to cause twitching.

In this embodiment of this application, action masking is performed, based on three different dependency limitation statuses and a determined object sub-action, on a sub-action of an action type on which decision-making is to be performed, to improve action decision-making efficiency in a high-dimensional complex action space and save computing resources to some extent.

In some embodiments, the character status information includes a plurality of pieces of scalar information that can describe a current situation status, and may be status information of the first virtual character and information about interaction between the first virtual character and an environment. Essentially, the environmental perception information is obtained by the first virtual character by perceiving a surrounding virtual environment, and describes a relative feature of the first virtual character relative to the virtual environment. Therefore, the action decision-making model can obtain sufficiently abundant and diverse relative features provided that the action decision-making model is trained in a sufficiently diverse virtual environment, to ensure that the action decision-making model has a capability of generalizing environmental perception.

However, the character status information may include some specific features that are strongly associated with a particular map scene. Therefore, the computer device performs further generalization based on the features.

In some embodiments, the computer device generalizes absolute status information included in the character status information, to obtain relative status information, the relative status information being status information of the first virtual character relative to another virtual character or an obstacle.

In some embodiments, absolute information may be replaced with relative information for generalization. For example, absolute location information or absolute location orientations of the first virtual character, another virtual character, and a bunker point are replaced with relative locations, namely, location orientations, between virtual characters and between a virtual character and a bunker point or an obstacle.

In this embodiment of this application, an action decision-making model with good generalization can be obtained through training by generalizing input information of the action decision-making model and with reference to various training scenarios, so that the action decision-making model can be easily deployed in various map scenes. The relative status information is more helpful for the first virtual character to make a decision and an action in a dynamic environment. Dependency on an absolute coordinate system is eliminated through generalization, so that a virtual character can more flexibly respond to a change in a surrounding environment. This improves perception and decision-making capabilities of the first virtual character, further enhances a strain capability and intelligent expressions in the dynamic environment, and effectively facilitates behavioral optimization and real-time response of a virtual character in a complex scene.

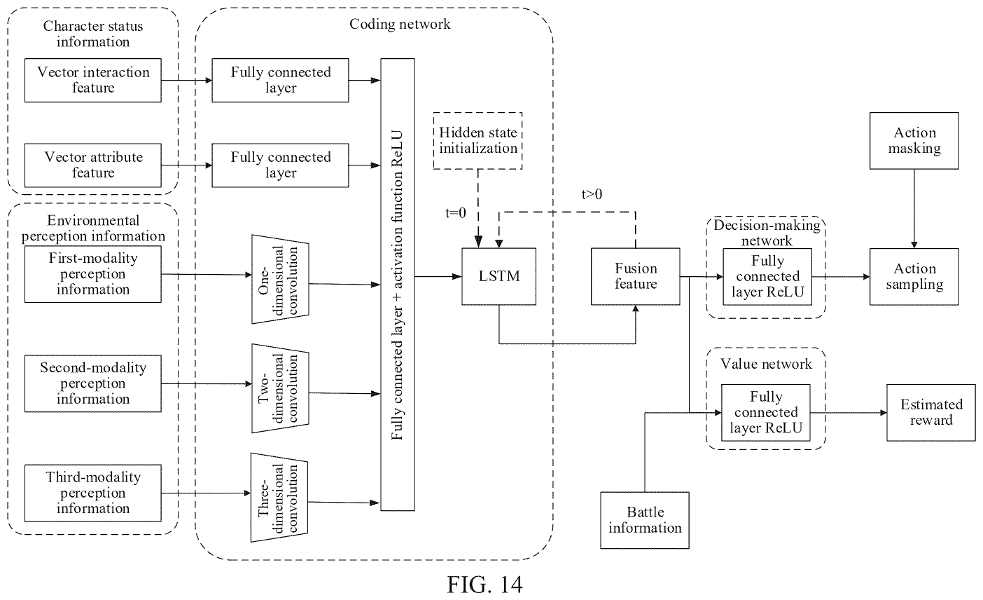

FIG. 14 is a schematic diagram of an action decision-making model according to an exemplary embodiment of this application. The action decision-making model includes a coding network, a decision-making network, an action masking network, and a value network. The computer device inputs the obtained character status information (including a vector interaction feature) and environmental perception information to the coding network in the action decision-making model for coding and concatenation, to obtain a concatenated feature. Then feature extraction is performed on the concatenated feature by using an LSTM network to obtain a fusion feature. The fusion feature is inputted to the decision-making network. The decision-making network includes a fully connected layer and an activation function ReLU. The decision-making network determines a character action based on the received fusion feature, masks a sub-action based on the action masking network during action decision-making, and finally determines an object sub-action through action sampling.

In addition, during training of the action decision-making model, the action decision-making model further includes the value network. Value evaluation is performed on a determined object sub-action by using the value network, and the action decision-making model is adjusted based on value obtained through evaluation. In addition, some battle information may be further inputted to the value network, so that the value network can determine estimated value of an object sub-action based on a current battle status.

Before the action decision-making model is applied, the action decision-making model is to be trained in a training battle. A training process of the action decision-making model is described below by using an exemplary embodiment.

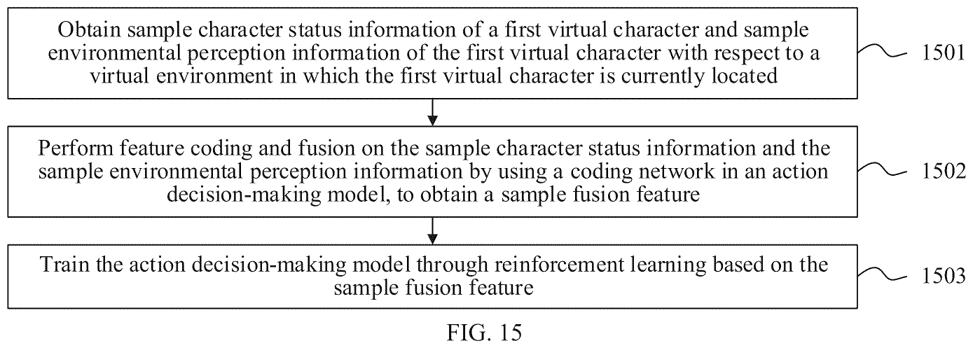

FIG. 15 is a flowchart of a training process of an action decision-making model according to an exemplary embodiment of this application. The process includes the following operations:

Operation 1501: Obtain sample character status information of a first virtual character and sample environmental perception information of the first virtual character with respect to a virtual environment in which the first virtual character is currently located.

Sample environmental perception information of different modalities in the sample environmental perception information has different information dimensions.

For a specific implementation of this operation, refer to the process of obtaining the character status information and the environmental perception information in operation 201. Details are not described herein again in this embodiment.

Operation 1502: Perform feature coding and fusion on the sample character status information and the sample environmental perception information by using a coding network in the action decision-making model, to obtain a sample fusion feature.

The coding network performs feature coding on the sample character status information and the sample environmental perception information of different modalities by using different coding schemes.

For a specific implementation of this operation, refer to the process of obtaining the fusion feature based on the character status information and the environmental perception information in operation 202. Details are not described herein again in this embodiment.

Operation 1503: Train the action decision-making model through RL based on the sample fusion feature.

Content of training the decision-making model based on the sample character status information and the sample environmental perception information is described in operation 1501 to operation 1503. A process of training the model corresponds to a process of applying the model to action decision-making. The training process helps improve robustness of the decision-making model and improve accuracy of the decision-making model in action decision-making.

A process of training the action decision-making model based on RL includes the following content:

Operation 1503a: Input the sample fusion feature to a decision-making network in the action decision-making model, to obtain an estimated character action.

Actually, a process of training the action decision-making model is a process of performing reinforcement training on the decision-making network in the action model.

For a specific implementation of this operation, refer to the content of determining a character action in the foregoing embodiments. Details are not described herein again in this embodiment.

Operation 1503b: Control the first virtual character to execute the estimated character action, to obtain an estimated action execution result of the first virtual character.

The estimated action execution result includes a change in the character status information of the first virtual character and a change in the environmental perception information perceived by the first virtual character after the first virtual character executes the estimated character action.

Operation 1503c: Determine an estimated action execution reward based on the estimated action execution result of the first virtual character.

During training, a specific task is set for the first virtual character. Therefore, to avoid that the first virtual character performs an extreme operation to complete the task, leading to a low personification degree of the first virtual character, in addition to estimating an execution reward of a character action based on a task progress, an execution reward of the estimated character action is further determined based on a personification degree of the estimated character action.

First, the computer device determines a weight coefficient ratio of reward and penalty items, including a dominant reward (a reward for a preset task progress) and an auxiliary personification reward. In an early stage of training of the action decision-making model, a weight coefficient of the dominant reward is increased, and a weight coefficient of the auxiliary personification reward is decreased, to enable the action decision-making model to preferentially perform learning with an objective of completing the task. After a plurality of rounds of training are performed, strength of the action decision-making model is continuously improved. Therefore, the weight coefficient of the auxiliary personification reward needs to be adjusted based on performance of the action decision-making model and a change trend of a corresponding personification indicator. The personification indicator is a degree of matching between a probability that the first virtual character executes a specific action and a probability that a real player executes a specific action. For example, when the first virtual character cannot properly use a bunker for a seesaw battle in a battle round, it can be determined that a weight of the dominant reward is excessively large. Therefore, the weight of the dominant reward is decreased, to ensure that the action decision-making model can determine a personified character action based on specific strength.

In this embodiment of this application, the estimated action execution reward mainly includes at least one of an attribute reward, a battle win reward, a battle loss reward, and a task reward.

The attribute reward mainly includes a health value attribute reward of the first virtual character. When an attribute value of the first virtual character decreases, the attribute reward is determined as the estimated action execution reward. For example, after the first virtual character executes the estimated character action, if the health value attribute of the first virtual character decreases, it is determined that the character action obtains a negative attribute reward. Alternatively, when the attribute value of the first virtual character increases, the attribute reward is determined as the estimated action execution reward. For example, after the first virtual character executes the estimated character action, if the health value attribute of the first virtual character increases, it is determined that the character action obtains a positive attribute reward.

The battle loss reward means that the first virtual character obtains a very large negative reward (namely, a penalty) when losing a battle. When the first virtual character loses a battle, the battle loss reward is determined as the estimated action execution reward.

The battle win reward is contrary to the battle loss reward. The first virtual character obtains a very large positive reward when winning a battle. When the attribute value of the first virtual character decreases, the attribute reward is determined as the estimated action execution reward.

In some embodiments, the first virtual character has a preset task in a battle, for example, guarding a treasure box, evading a pursuit, or reaching a specified location. Therefore, when the first virtual character successfully completes a task in a training battle, the task reward is determined as the estimated action reward.

In addition, to enable the action decision-making model to perform personified action decision-making, the estimated action reward further includes a personification reward. The computer device determines personification attribute values of the at least two estimated character actions based on estimated action execution results of executing at least two estimated character actions by the first virtual character in the training battle. The personification attribute values may be quantities of times of executing specific actions, movement locations of at least two estimated character actions that are continuously determined, or the like. When the personification attribute values are less than a personification attribute threshold, the personification reward is determined as the estimated action execution reward.

For example, Table 3 shows an estimated action execution reward according to an exemplary embodiment of this application.

TABLE 3

| Category | Subcategory | Reward and penalty settings |
|---|---|---|
| Dominant reward | Task reward | Attribute change |
| | | Battle win/loss |
| | | Whether the task succeeds |
| Auxiliary | Posture | Proper leaning |
| personification | personification | Proper squatting |
| reward | reward | Proper silent steps |
| | | Penalty for sharp turning |
| | | Movement dispersion |
| | Combat | Ratio of attacking after three |
| | personification | seconds of evasion |
| | reward | Ratio of attacking after 2.5 |
| | | seconds of evasion |
| | | Bunker utilization |
| | | Stay in dangerous areas |
| | | Shooting and withdrawing |
| | | Ambush in the dark |
| | | Remote attack |
| | | Attacking when an opponent |
| | | approaches |
| | | Peeking at a dangerous moment |
| | | Ratio of attacking |

In the foregoing table, some estimated action rewards need to be determined based on a plurality of consecutive estimated character actions. For example, proper leaning is a personification reward. A virtual character controlled by a real player usually does not perform leaning for a plurality of times within a short time, or perform leaning without a bunker around. Therefore, among a plurality of determined character actions, when a personification attribute value of a leaning action (to be specific, a quantity of times of leaning actions) exceeds the personification attribute threshold, the leaning action is determined as improper leaning, and a negative reward is given based on the action decision-making model.

Table 3 includes a movement dispersion reward, a bunker utilization reward, a reward for an ambush in the dark, and a proper action reward (proper leaning, proper squatting, proper silent steps, and the like).
1. The movement dispersion reward is a reward given for a reduction in closeness of a plurality of consecutive movements when the first virtual character executes an estimated action. To be specific, the first virtual character does not continuously wander in situ for a plurality of times, and can move on a large-scale map in a more dispersed manner, to explore different locations on the map.

In some embodiments, the estimated action execution result includes a location point obtained after the first virtual character executes the first n+1 actions. The computer device determines, based on a location point obtained after the first virtual character executes an (n+1)^{th} estimated character action, first closeness between the location point obtained after the (n+1)^{th} action is executed and a location point obtained after the first n actions are executed; determines second closeness between a location point obtained after an nth action is executed and a location point obtained after the first n−1 actions are executed; and determines the movement dispersion reward as the estimated action execution reward when the first closeness is less than the second closeness. During training of the action decision-making model, the first virtual character may get stuck in a local area and circle around. Therefore, the first virtual character may be guided, based on a closeness centrality algorithm, to perform an estimated character action determined by the action decision-making model through decision-making, so that movements are sufficiently dispersed, and movement routes cover a global map as much as possible, to train a movement capability of the first virtual character.

In some embodiments, when the first closeness between the location point obtained after the (n+1)^{th} action is executed and the location point obtained after the first n actions are executed is less than the second closeness between the location point obtained after the nth action is executed and the location point obtained after the first n−1 actions are executed, it is determined that a positive movement dispersion reward is obtained. Alternatively, when closeness between the location point obtained after the (n+1)^{th} action is executed and the location point obtained after the first n actions are executed is greater than closeness between the location point obtained after the nth action is executed and the location point obtained after the first n−1 actions are executed, it is determined that a negative movement dispersion reward is obtained. In this way, the first virtual character is guided to move away from a recently visited historical location as far as possible, to prevent the virtual character from wandering in situ.

The foregoing process describes content of using the movement dispersion reward as the estimated action execution reward. Rewards are given for location changes of the first virtual character in different time periods, so that more diversified tactical strategies and movement modes are encouraged, and tactical depth and challenge in a game or simulation are increased. The movement dispersion reward also makes it more difficult to predict the first virtual character by an opponent in a combat or competitive environment, so that survivability and an escape capability of the first virtual character are improved. In addition, consideration of closeness evaluation on location points helps better optimize the action decision-making model, so that the action decision-making model can select and execute an action more intelligently, to maximize a reward and improve overall performance.
2. The bunker utilization reward is a reward given for a location of the first virtual character being adjacent to a bunker when the first virtual character executes an estimated action. When another virtual character exists, the first virtual character is expected to be located near the bunker as close as possible, to avoid being attacked by the another virtual character.

In some embodiments, the estimated action execution result includes sample environmental perception information obtained after the first virtual character executes the estimated character action, the sample environmental perception information includes a two-dimensional depth map, and the two-dimensional depth map is configured for representing a status of masking the first virtual character by an obstacle in an orientation direction of the first virtual character.

The computer device performs area division on the two-dimensional depth map to obtain at least two depth areas; determines a first masking rate of a first depth area and a second masking rate of at least two second depth areas adjacent to the first depth area, the first depth area being located at a center of a field of view of the first virtual character; determines the bunker utilization reward based on a minimum difference between the first masking rate and the second masking rate, a reward degree of the bunker utilization reward being positively correlated with the minimum difference; and determines the bunker utilization reward as the estimated action execution reward.

The foregoing content describes content of performing area division on the two-dimensional depth map and determining the bunker utilization reward based on masking rates of the areas. By evaluating and giving a reward for bunker utilization, the first virtual character can be encouraged to select a better bunker location in a combat, to optimize a defense or attack capability of the first virtual character. In view of a difference between masking rates of depth areas, a virtual character is encouraged to select a location that can provide a better field of view and better protection, to enhance tactical awareness and a visual strategy capability of the virtual character. This not only increases tactical depth of a game, but also improves combat experience of a player, so that the game is more vivid and challenging.

In this embodiment of this application, the bunker utilization reward is determined by reshaping a depth map matrix. In a game scene, a bunker is an area providing shielding for the first virtual character during a combat of the first virtual character. A plurality of bunkers exist in a virtual environment, and different bunkers have at least one of different locations, different orientations, and different shapes. The two-dimensional depth map can represent a depth status of an obstacle in the orientation direction of the first virtual character. Therefore, a pixel distribution area of a bunker may be determined based on a pixel value distribution status of the two-dimensional depth map.

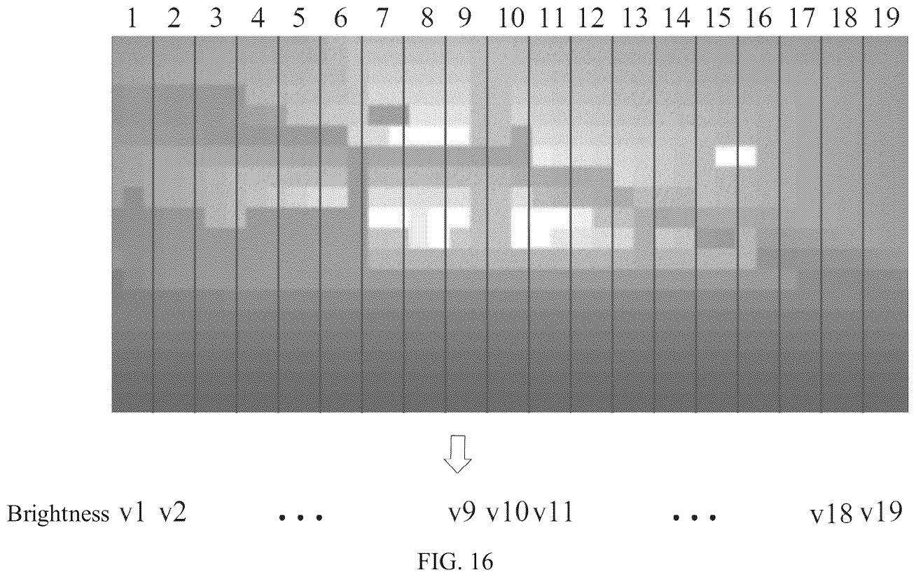

FIG. 16 is a schematic diagram of performing area division on a depth map according to an exemplary embodiment of this application. Division is performed based on a direction of values of the depth map to obtain a total of 19 areas: 1 to 19. The depth map is vertically divided into several columns, and a brightness rate of each column is calculated. A larger brightness rate indicates higher brightness in front, a lower possibility of being blocked by an obstacle, and a lower masking rate. During application, the first virtual character is expected to select an area in which a bunker exists and another virtual character can be attacked. Therefore, a middle column of the depth map is expected to have a smallest brightness rate. Because the middle column indicates field-of-view information in front of the first virtual character, a smaller brightness rate indicates a larger masking rate and a higher possibility that a bunker area exists in front. In addition, the first virtual character is expected to be located at an edge of a bunker, to be specific, be able to initiate an attack to another virtual character through a leaning action or the like. Therefore, an absolute value of a difference between a brightness rate of the middle column and a larger one of brightness rates of two columns on the left and right of the middle column is to be kept as large as possible, in other words, a minimum value of differences between the brightness rate of the middle column and the brightness rates (masking rates) of the two columns on the left and right of the middle column is kept as large as possible. Correspondingly, in FIG. 16, it is expected that a masking rate of the tenth column is as large as possible, and a masking rate of an area in the ninth column and the eleventh column is as small as possible.

In some embodiments, a brightness rate vⱼ corresponding to a depth area may be calculated by using the following formula:

$${v}_{j} = \frac{{\sum }_{i = 1}^{i = n} {x}_{i , j}}{{\sum }_{i = 1}^{i = n} 1}$$

vⱼ is a ratio of an actual pixel in each depth area to a theoretical maximum sum of pixels in each column, and a masking rate of the depth area is 1−vⱼ. In this case, the bunker utilization reward may be calculated by using the following formula:

$$r = α \cdot ( 1 - {v}_{10} ) + β \cdot \vert 1 - {v}_{10} - min ( 1 - {v}_{9} , 1 - {v}_{11} ) \vert$$

r is the bunker utilization reward, and α REL β are reward hyperparameters.

Area division may alternatively be performed on the two-dimensional depth map based on a horizontal direction, or a quantity of areas obtained through division may be adjusted based on a virtual environment. When the virtual environment is complex, more depth areas may be used to perform finer-grained division on the two-dimensional depth map, to achieve finer-grained bunker effect. When a map scene is large, a control structure is simple, and therefore depth area division may be performed at a coarse granularity. This is not limited in this embodiment.
3. The reward for an ambush in the dark is a visibility reward. The visibility reward is a reward given for a location of a virtual character being an effective attack location with respect to another virtual character when the virtual character executes an estimated action. When another virtual character exists, it is expected that the another virtual character can be at a location visible to the first virtual character but the first virtual character is not at a location visible to the another virtual character, to facilitate attacking.

In some embodiments, the estimated action execution result includes a mutual visibility relationship between the first virtual character and another virtual character, and the mutual visibility relationship is configured for representing a visibility status of the first virtual character and the another virtual character relative to each other.

The computer device determines that the estimated action execution reward is a positive visibility reward when the mutual visibility relationship indicates that the first virtual character is not within a visibility range of the another virtual character and the another virtual character is within a visibility range of the first virtual character; or
determines that the estimated action execution reward is a negative visibility reward when the mutual visibility relationship indicates that the first virtual character is within a visibility range of the another virtual character and the another virtual character is not within a visibility range of the first virtual character.

That is, when the first virtual character is at a location conducive to attacking relative to the another virtual character, it is determined that a positive visibility reward is obtained; and on the contrary, when the first virtual character is at a location not conducive to attacking relative to the another virtual character, it is determined that a negative visibility reward is obtained.

In some embodiments, the mutual visibility relationship may be obtained through ray detection. An environmental perception ray is transmitted to each part of another virtual character in an orientation direction of the first virtual character by using an eye location of the first virtual character as a starting point. A visibility status of each part of the another virtual character in the virtual environment is determined based on a reflection status of the environmental perception ray, the visibility status being configured for representing whether each part of the another virtual character is blocked by a bunker. When the visibility status indicates that all parts of the another virtual character are blocked by an obstacle, it is determined that the another virtual character is not within the visibility range of the first virtual character. Similarly, an environmental perception ray is transmitted to each part of the first virtual character in an orientation direction of another virtual character by using an eye location of the another virtual character as a starting point, and a visibility status of each part of the first virtual character is determined. When the visibility status indicates that all parts of the first virtual character are blocked by an obstacle, it is determined that the first virtual character is not within a visibility range of the another virtual character.

The foregoing content describes a process of determining directionality of an estimated action execution reward based on a mutual visibility relationship between virtual characters. A positive visibility reward encourages a virtual character to take an action without awareness of another character. This may be used to enhance strategies such as sneaking, concealing, and executing tactical attacks, to improve combat depth and tactical choices in a game or simulation environment. A negative visibility reward encourages a virtual character to take an action when being discovered by another character. This can encourage quick response, avoid exposure, and help implement a defense strategy, to help improve survivability of a virtual character and game experience. In this way, behavioral choices of a virtual character in a game or simulation environment are effectively enriched, and overall game experience and participation are improved.
4. The proper action reward is a reward given for conformity to operation logic of a real player when the first virtual character executes an estimated action. During model training, it is expected that a behavior of the first virtual character can be personified as much as possible and the first virtual character can perform a behavior better conforming to human logic.

Before determining the estimated character action, the computer device determines an ideal action of the first virtual character based on the sample character status information and the sample environmental perception information of the first virtual character. For example, if the environmental perception information represents that a low-profile bunker exists in front of the first virtual character, the ideal action of the first virtual character may be a squatting action. For another example, if the environmental perception information represents that another virtual character exists on the right of the first virtual character, it can be determined that the ideal action is turning right.

Then, when the estimated character action corresponding to the action decision-making model is consistent with the ideal action, the proper action reward is determined as the estimated action execution reward.

The foregoing content describes a case in which an ideal action is determined based on virtual character status information and environmental perception information and a proper action reward is determined based on the ideal action. Calculating an ideal action by combining a character status and environment information can help a virtual character make a more intelligent action choice based on a scene. This improves overall performance and intelligence of a game or simulation system, and also enables a player to interact with the virtual character more intuitively, because the virtual character presents intelligence and vividness closer to a real behavior. In addition, giving a reward for a proper action effectively encourages effective resource utilization and efficient task execution, so that action execution efficiency and performance are optimized.

In some embodiments, environmental perception rays are transmitted toward a plurality of directions by using the first virtual character as a starting point. Different environmental perception rays are located at a same horizontal height, and the environmental perception rays are reflected along normal directions of the environmental perception rays when the environmental perception rays collide with a surface of an obstacle. When reflection statuses of the environmental perception rays indicate that a projection distance of a first environmental perception ray is less than a distance threshold, a transmitting direction of an environmental perception ray that is adjacent to the first environmental perception ray and whose projection distance is greater than the distance threshold is determined as an ideal turning direction. The projection distance is a distance between a starting point and a reflection point of the environmental perception ray. When a turning direction indicated by the turning sub-action is consistent with the ideal turning direction, the proper action reward is determined as the estimated action execution reward.

Calculating an ideal turning direction by using environmental perception rays enables a virtual character to more effectively avoid an obstacle and select an optimal path, to optimize a movement capability and a navigation capability of the virtual character. A behavior of reflecting light by an object in the real world is simulated, to make the virtual environment more vivid and challenging. Giving a reward for a proper action not only improves operation efficiency of the virtual character, but also optimizes a response speed and an intelligence level during processing of a complex scene and a dynamic environment. This helps improve human-computer interaction efficiency.

The foregoing content describes implementations of the estimated action execution reward. According to at least one of the foregoing four rewards, different reward mechanisms not only can optimize behavioral decision-making of the first virtual character, but also can improve performance and player experience in a game or simulation environment. According to the design and implementation of the proper action reward, the bunker utilization reward, the visibility reward, and the movement dispersion reward, tactics and strategy selection in the real world can be more effectively simulated, to improve intelligence and vividness of the first virtual character.

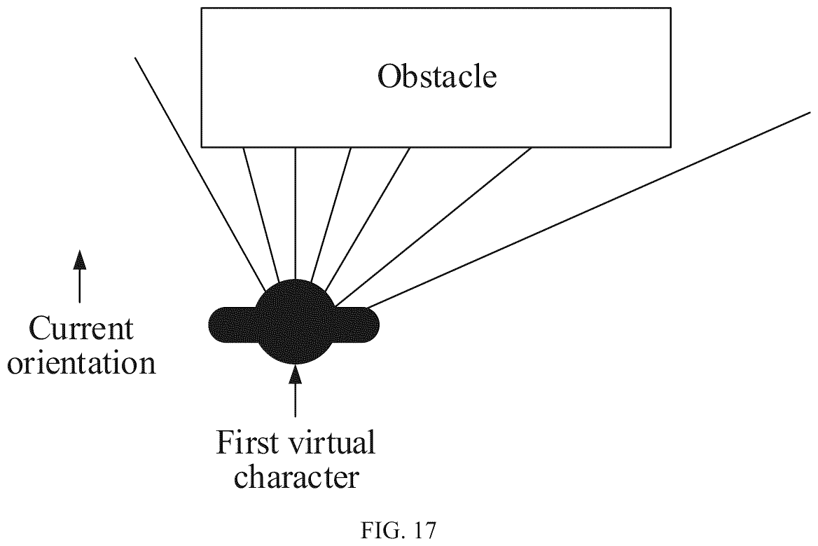

For example, FIG. 17 shows a character action including a turning sub-action according to an exemplary embodiment of this application. In this case, the computer device transmits environmental perception rays toward a plurality of directions by using the first virtual character as a starting point, and different environmental perception rays are located at a same horizontal height. The computer device determines a surrounding obstacle distribution based on reflection statuses of the environment-perceived rays. In FIG. 17, when a length of a shortest environmental perception ray is less than a distance threshold, the first virtual character is close to an obstacle, and it can be determined that turning needs to be performed in this case. The environmental perception rays diffuse to the left and right with the shortest ray as a reference. The computer device determines that a ray direction (a counterclockwise direction of the first virtual character) in which a ray length exceeds the distance threshold earlier is an ideal turning direction of the first virtual character.

When a turning direction determined by the action decision-making model is consistent with the ideal turning direction, the proper action reward is determined as the estimated action execution reward. When a turning direction determined by the action decision-making model is inconsistent with the ideal turning direction, the first virtual character may get stuck in a wall, and a negative reward is given.

Operation 1503d: Update a model parameter of the action decision-making model based on the estimated action execution reward.

A process of updating the action decision-making model based on the estimated action execution reward is a process of modifying the model parameter of the decision-making model to obtain a larger estimated action execution reward. In this way, the action decision-making model can implement action personification as much as possible when performing a preset task.

In this embodiment of this application, during training of the action decision-making model, an auxiliary personification action reward is added, to meet dual requirements for model strength and personification. While a character behavior of the first virtual character is accurately predicted and controlled, personification of the first virtual character is greatly improved through action masking logic. A reward for an actual execution result may be instantly fed back to the action decision-making model. Therefore, a decision-making policy of the model is optimized based on the feedback of the reward, so that the decision-making policy is gradually improved and optimized, to better adapt to various scenarios and challenges and better conform to behavioral logic of a real player.

In this embodiment of this application, at least one another virtual character exists in a battle to which the first virtual character belongs, and the another virtual character executes an action outputted by a second action decision-making model. In some scenarios, a task of the another virtual character corresponds to a task of the first virtual character. For example, the task of the first virtual character is guarding a treasure box, and the task of the another virtual character may be grabbing a treasure box.

The another virtual character is an opponent virtual character. After a first action decision-making model corresponding to the first virtual character is trained, the second action decision-making model also needs to be iterated, to obtain second action decision-making models with different strength.

In some embodiments, when one round of training on the first action decision-making model corresponding to the first virtual character is completed, the second action decision-making model is trained based on a trained first action decision-making model, and a second action decision-making model obtained through one round of training is stored to an opponent model pool. The opponent model pool includes a second action decision-making model obtained through at least one round of training.

When a next round of training is performed on the first decision-making model, a previous second decision-making model is obtained, as an opponent, from the opponent model pool through sampling according to a specific rule, to perform the next round of training. The computer device selects the trained second action decision-making model from the opponent model pool, and constructs a new battle. The new battle includes the first virtual character that executes an estimated character action outputted by the first action decision-making model and the another virtual character that executes an estimated character action outputted by the second action decision-making model. Then the first action decision-making model is trained in the new battle.

For example, a specific process is as follows:
(1) Perform a 0^{th} round of training on the first action decision-making model by controlling the opponent virtual character based on a built-in behavior tree of a client. (2) Store a model obtained through the 0^{th} round of training to an evaluation model pool for evaluation. (3) Perform a 0^{th} round of training on the second action decision-making model based on the first action decision-making model obtained through the 0^{th} round of training, and add a trained second action decision-making model to the opponent model pool. (4) Select a previously trained second decision-making model from the opponent model pool as an opponent, and perform a K^{th} round of training on the first action decision-making model. (5) Store a first action decision-making model obtained through the K^{th} round of training to the evaluation model pool for evaluation. (6) Perform a K^{th} round of training on the second action decision-making model based on the first action decision-making model obtained through the K^{th} round of training, and store a trained second action decision-making model to the opponent model pool. (7) Repeat the operations in (4) to (6) until an evaluation result of the first action decision-making model meets a performance evaluation result, and determine that training of the first action decision-making model is completed.

The foregoing content describes a process of training an action decision-making model of a virtual character and constructing a battle. A learning process of a second model is accelerated based on training experience of a first model, so that a plurality of decision-making models can be optimized more quickly. A plurality of trained models are stored in the opponent model pool, to help construct a more challenging and changeable battle, and improve an adversarial learning capability and adaptability of a virtual character. The first action decision-making model is trained and adjusted in an actual battle, so that a behavioral policy and an intelligence level of a character can be continuously optimized, to adapt to a complex and dynamic game or simulation environment.

In a possible implementation, to enable the first action decision-making model to be personified while having specific strength, the following several sparring behaviors may be added for the opponent virtual character:
1. Create an opponent virtual character for a full sprint pursuit, to help train a capability of the first virtual character for full-map exploration.
2. Set a generation point of the opponent virtual character to a random generation point, and setting a cooldown period for the opponent virtual character when the generation point of the opponent virtual character is close to that of the first virtual character, to prevent the first virtual character from being instantly defeated at the beginning of a battle during training.
3. When a distance between the opponent virtual character and the first virtual character is less than a safe distance, determine that the first virtual character loses the battle. This can train the first virtual character to keep a specific distance from the opponent virtual character, and can also prevent the first virtual character from being stuck in a terrain.
4. Enable the opponent virtual character to move to the front of the first virtual character at a low probability, to simulate a scenario of the first virtual character in a real player dimension, and improve strength of the first virtual character.

In this embodiment of this application, the second action decision-making model corresponding to the opponent virtual character for sparring and the first decision-making model corresponding to the first virtual character are trained, to improve strength of the first decision-making model, and enable the first decision-making model to have a stable action decision-making capability.

In this embodiment of this application, whether training of the action decision-making model is completed needs to be determined based on both a battle indicator and a personification indicator. The battle indicator is configured for evaluating strength of the action decision-making model, and the personification indicator is configured for evaluating a degree of personification of the action decision-making model.

Table 4 shows a battle indicator and a personification indicator according to an exemplary embodiment of this application.

TABLE 4

| | | Personification indicator (500 battles are | |
|---|---|---|---|
| | | counted, and an average personification | |
| Battle indicator | | indicator of each battle is calculated) | |
| Tie rate | A battle between two parties is | Leaning rate | Proper leaning is performed to |
| | ended as a tie. | | attack the opponent virtual |
| | | | character. |
| Win rate | The first virtual character | Crouching | Probability that the first virtual |
| | defeats the opponent virtual | rate | character performs a proper |
| | character. | | squatting action to hide itself to |
| | | | avoid being discovered by the |
| | | | opponent |
| Loss rate | The first virtual character is | Evasion rate | Average proportion of not |
| | defeated by the opponent | | being discovered in a round of |
| | virtual character. | | game |
| Attacking- | Quantity of frames of | Silent step | Proportion of the first virtual |
| upon- | attacking upon encountering | rate | character muting sound |
| encounter | an enemy/Total quantity of | | through silent steps to avoid |
| rate | frames of encountering an | | being discovered |
| | enemy | | |
| Effective | Quantity of frames of hitting | Bunker | Proportion of the first virtual |
| firing rate | an enemy upon | utilization | character hiding itself by using |
| | encountering/Total quantity of | rate | a bunker |
| | frames of attacking upon | | |
| | encountering an enemy | | |
| Survival time | Survival duration of the first | Movement | The first virtual character |
| | virtual character in a round of | dispersion | moves flexibly, without staying |
| | game | rate | at a same location for a long |
| | | | time. |
| Quantity of | Quantity of frames in which | Rate of | Frequency at which the first |
| times of | the first virtual character is | staying in | virtual character is in a |
| getting stuck | within 30° of a field of view | dangerous | dangerous clear area without a |
| in a wall | and is less than 0.5 m away | areas | bunker in a specific combat |
| | from an obstacle | | scene |
| | | Sharp | A moving orientation of the |
| | | turning rate | first virtual character is not to |
| | | | change sharply. |
| | | Retreat- | When shooting the opponent |
| | | from-attack | virtual character, the first |
| | | rate | virtual character can actively |
| | | | move away from the opponent |
| | | | virtual character while |
| | | | shooting. |
| | | Secret | The first virtual character |
| | | shooting | shoots beyond a field of view |
| | | rate | of the opponent virtual |
| | | | character. |
| | | Dogfight | Configured for describing an |
| | | rate | anthropomorphic behavior of |
| | | | performing a seesaw battle by |
| | | | using a bunker |

During determining of the personification indicator, an average personification indicator is determined based on a large amount of battle data.

The computer device obtains battle data of an i^{th} round of training battle when an i^{th} round of training on the action decision-making model is completed; and determines a battle indicator and a personification indicator based on battle data of at least two rounds of training battles, the personification indicator being an actual execution proportion of a specific action in the battle data of at least the training battles.

When the battle indicator reaches a training completion criterion and the personification indicator matches an action execution proportion of executing the specific action by a real player in a battle, it is determined that training on the action decision-making model is completed.

In this embodiment of this application, both the battle indicator and the personification indicator are used as evaluation criteria for the action decision-making model, so that a trained action decision-making model can achieve a balance between strength and a personification degree of the action model. This not only improves performance and practicability of the action decision-making model, and but also can ensure good performance of the action decision-making model in diversified battle scenes, to meet expectations and requirements of real players.

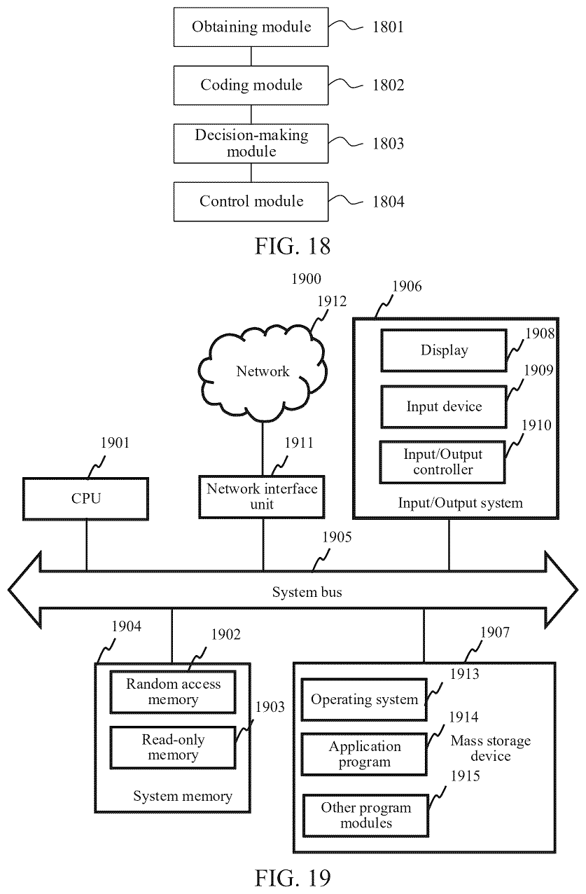

FIG. 18 is a schematic structural diagram of an action decision-making apparatus for a virtual character according to an exemplary embodiment of this application. The apparatus includes the following structure:
an obtaining module 1801, configured to obtain character status information of a first virtual character and obtain environmental perception information of the first virtual character with respect to a virtual environment in which the first virtual character is currently located, the environmental perception information including perception information of a plurality of modalities, and the plurality of modalities each representing one information dimension;
a coding module 1802, configured to fuse a coding result corresponding to the character status information and a coding result corresponding to the environmental perception information, to obtain a fusion feature, the coding result being a result obtained by separately performing feature coding on the character status information and a plurality of pieces of perception information by using different coding schemes;
a decision-making module 1803, configured to perform action decision-making on the first virtual character based on the fusion feature to obtain a character action; and
a control module 1804, configured to control the first virtual character to execute the character action.

In some embodiments, the environmental perception information includes first-modality perception information, second-modality perception information, and third-modality perception information.

The obtaining module 1801 is configured to: obtain the first-modality perception information through ray detection based on a character location of the first virtual character in the virtual environment, the first-modality perception information being a one-dimensional vector, and the first-modality perception information being configured for representing a depth status of an obstacle at a same horizontal height around the first virtual character; obtain the second-modality perception information through ray detection based on the character location of the first virtual character in the virtual environment and an orientation of the first virtual character, the second-modality perception information being a two-dimensional depth map in an orientation direction of the first virtual character, and the second-modality perception information being configured for representing a depth status of an obstacle in the orientation direction of the first virtual character; and obtain the third-modality perception information of the virtual environment within a preset range of the first virtual character through ray detection based on the character location of the first virtual character in the virtual environment, the third-modality perception information being a three-dimensional occupancy grid map, and the third-modality perception information being configured for representing a spatial distribution status of obstacles within the preset range.

In some embodiments, the obtaining module 1801 is configured to: transmit environmental perception rays in a plurality of directions by using at least two heights of the character location of the first virtual character as starting points, the environmental perception rays being reflected along normal directions of the environmental perception rays when the environmental perception rays collide with a surface of an obstacle, and transmitting directions of environmental perception rays transmitted at a same height are at a same horizontal height; and generate the first-modality perception information based on reflection statuses of the environmental perception rays.

In some embodiments, the obtaining module 1801 is configured to: transmit an environmental perception ray toward the orientation direction of the first virtual character by using the first virtual character as a starting point, the environmental perception ray being reflected along a normal direction of the environmental perception ray when the environmental perception ray collides with a surface of an obstacle; and generate the second-modality perception information based on a reflection status of the environmental perception ray.

In some embodiments, the obtaining module 1801 is configured to: divide the virtual environment within the preset range of the first virtual character by using an occupancy grid, the occupancy grid including a plurality of cubes with a same volume; and transmit environmental perception rays from starting points of at least two directions in the virtual environment to the occupancy grid, and generate the third-modality perception information based on reflection statuses of the environmental perception rays. In some embodiments, action decision-making is performed on the first virtual character by using an action decision-making model, and the action decision-making model includes a coding network and a decision-making network.

The coding module 1802 is configured to: input the character status information and the environmental perception information to the action decision-making model, and code the character status information and the environmental perception information by using the coding network, to obtain a status information coding result corresponding to the character status information and a perception information coding result corresponding to the environmental perception information to obtain a concatenated feature; concatenate the status information coding result and the perception information coding result to obtain a concatenated feature code; and perform feature extraction on the concatenated feature code by using the coding network, to obtain the fusion feature.

In some embodiments, the coding network includes a status information coder and a perception information coder, the perception information coder includes convolution kernels of a plurality of dimensions, and the convolution kernels of the plurality of dimensions are respectively configured to perform feature coding on the perception information of the plurality of modalities.

The coding module 1802 is configured to: code the character status information by using the status information coder, to obtain the status information coding result corresponding to the character status information; code the first-modality perception information by using a one-dimensional convolution kernel in the perception information coder, to obtain a first perception information coding result; code the second-modality perception information by using a two-dimensional convolution kernel in the perception information coder, to obtain a second perception information coding result; and code the third-modality perception information by using a three-dimensional convolution kernel in the perception information coder, to obtain a third perception information coding result, the first perception information coding result, the second perception information coding result, and the third perception information coding result constituting the perception information coding result.

In some embodiments, the character status information includes absolute status information, and the absolute status information is configured for representing status information, irrelevant to another virtual character or an obstacle, of the first virtual character in the virtual environment.

The apparatus further includes a generalization module, configured to generalize the absolute status information included in the character status information, to obtain relative status information, the relative status information being status information of the first virtual character relative to another virtual character or an obstacle.

In some embodiments, the decision-making network includes n action output heads, the n action output heads are configured to serially output n object sub-actions, different action output heads correspond to different action types, the n action output heads are serially connected based on a dependency relationship between the action types, the dependency relationship is configured for representing a dependency limitation status between sub-actions of different action types, the n object sub-actions constitute the character action, and n is a positive integer greater than 2.

The decision-making module 1803 includes: inputting the fusion feature to a first action output head in the decision-making network, and determining a first object sub-action from sub-actions of a first action type by using the first action output head in the decision-making network; and inputting, to an i^{th} action output head, the fusion feature and embedded coding vectors corresponding to the first object sub-action to an (i−1)^{th} object sub-action that are determined, and determining an i^{th} object sub-action from sub-actions of an i^{th} action type by using the i^{th} action output head, i being a positive integer greater than 1. In some embodiments, at least two of the n action output heads correspond to a same action type, the i^{th} action output head among the n action output heads corresponds to a coarse-grained sub-action, a j^{th} action output head among the n action output heads corresponds to a fine-grained sub-action, i is less than j, and j is a positive integer greater than 2.

The decision-making module 1803 includes: determining the i^{th} object sub-action from the coarse-grained sub-action by using the i^{th} action output head in the decision-making network; and determining a j^{th} object sub-action from the fine-grained sub-action by using the j^{th} action output head based on a fusion vector and an embedded coding vector corresponding to the i^{th} object sub-action, an action range indicated by the j^{th} object sub-action being less than an action range indicated by an i^{th} character action.

In some embodiments, the apparatus further includes:
an action masking module, configured to perform, based on the first object sub-action to the (i−1)^{th} object sub-action that are determined and a dependency limitation status between different sub-actions of different action types, action masking on a sub-action of the i^{th} action type corresponding to the i^{th} action output head, at least two sub-actions that have a dependency limitation relationship and that are indicated by the dependency limitation status being unable to be simultaneously executed, and the action masking being configured for masking an inappropriate sub-action or an invalid sub-action.

The decision-making module 1803 includes: determining the i^{th} object sub-action from unmasked sub-actions of the i^{th} action type by using the i^{th} action output head.

In some embodiments, the apparatus further includes:
a determining module, configured to: transmit an environmental perception ray to each part of another virtual character in the orientation direction of the first virtual character by using an eye location of the first virtual character as a starting point; and determine a visibility status of each part of the another virtual character in the virtual environment based on a reflection status of the environmental perception ray, the visibility status being configured for representing whether each part of the another virtual character is blocked by a bunker.

The masking module is configured to perform action masking on a sub-action of a character action type based on the visibility status of each part of the another virtual character, an object sub-action having the dependency limitation relationship with the visibility status of each part of the another virtual character.

The decision-making module 1803 includes: determining the object sub-action from unmasked sub-actions of the character action type by using a character action output head.

In some embodiments, a first turning action output head among the n action output heads corresponds to a coarse-grained turning action, a second turning action output head among the n action output heads corresponds to a fine-grained turning action, the first turning action output head is configured to determine a first turning angle, and the second turning action output head is configured to determine a second turning angle.

The determining module is further configured to: determine an ideal turning angle based on an orientation of the first virtual character, location coordinates of the first virtual character, and location coordinates of the another virtual character; determine an aiming distance between the first virtual character and the another virtual character; and determine an effective aiming range based on the aiming distance and a width of the another virtual character.

The action masking module is configured to: determine an angle difference between the first turning angle and the ideal turning angle based on the first turning angle determined by the first turning action output head; determine an effective fine-grained turning angle based on the angle difference and the effective aiming range; and perform action masking on a turning angle, in the coarse-grained turning action, that does not belong to the effective fine-grained turning angle.

The decision-making module 1803 is configured to determine the second turning angle from unmasked effective fine-grained turning angles in the fine-grained turning action by using the second turning action output head.

In some embodiments, the apparatus further includes:
a training module, configured to obtain sample character status information of the first virtual character and sample environmental perception information of the first virtual character with respect to the virtual environment in which the first virtual character is currently located, the sample environmental perception information including sample perception information of a plurality of modalities, and the plurality of modalities each representing one information dimension.

The training module is further configured to fuse, by using the coding network in the action decision-making model, a sample coding result corresponding to the sample character status information and a sample coding result corresponding to the sample environmental perception information, to obtain a sample fusion feature, the coding network performing feature coding on the sample character status information and sample environmental perception information of different modalities by using different coding schemes.

The training module is further configured to train the action decision-making model based on the sample fusion feature through reinforcement learning.

In some embodiments, the training module is configured to: input the sample fusion feature to the decision-making network in the action decision-making model, to obtain an estimated character action; control the first virtual character to execute the estimated character action, to obtain an estimated action execution result of the first virtual character; determine an estimated action execution reward based on the estimated action execution result of the first virtual character; and update a model parameter of the action decision-making model based on the estimated action execution reward.

In some embodiments, the estimated action execution reward includes at least one of a proper action reward, a bunker utilization reward, a visibility reward, and a movement dispersion reward.

The proper action reward is a reward given for conformity to operation logic of a real player when the first virtual character executes the estimated character action. The bunker utilization reward is a reward given for a location of the first virtual character being adjacent to a bunker when the first virtual character executes the estimated character action. The visibility reward is a reward given for a location of the virtual character being an effective attack location with respect to another virtual character when the virtual character executes the estimated character action. The movement dispersion reward is a reward given for a reduction in closeness of a plurality of consecutive movements when the first virtual character executes the estimated character action.

In some embodiments, the estimated action execution result includes a location point obtained after the first virtual character executes the first n+1 actions.

The training module is configured to: determine, based on a location point obtained after the first virtual character executes an (n+1)^{th} estimated character action, first closeness between the location point obtained after the (n+1)^{th} action is executed and a location point obtained after the first n actions are executed, and determine second closeness between a location point obtained after an nth action is executed and a location point obtained after the first n−1 actions are executed; and determine the movement dispersion reward as the estimated action execution reward when the first closeness is less than the second closeness.

In some embodiments, the estimated action execution result includes the sample environmental perception information obtained after the first virtual character executes the estimated character action, the sample environmental perception information includes a two-dimensional depth map, and the two-dimensional depth map is configured for representing a status of masking the first virtual character by the obstacle in the orientation direction of the first virtual character.

The training module is configured to: perform area division on the two-dimensional depth map to obtain at least two depth areas; determine a first masking rate of a first depth area and a second masking rate of at least two second depth areas adjacent to the first depth area, the first depth area being located at a center of a field of view of the first virtual character; determine the bunker utilization reward based on a minimum difference between the first masking rate and the second masking rate, a reward degree of the bunker utilization reward being positively correlated with the minimum difference; and determine the bunker utilization reward as the estimated action execution reward.

The estimated action execution result includes a mutual visibility relationship between the first virtual character and another virtual character, and the mutual visibility relationship is configured for representing a visibility status of the first virtual character and the another virtual character relative to each other.

The training module is configured to: determine that the estimated action execution reward is a positive visibility reward when the mutual visibility relationship indicates that the first virtual character is not within a visibility range of the another virtual character and the another virtual character is within a visibility range of the first virtual character; or determine that the estimated action execution reward is a negative visibility reward when the mutual visibility relationship indicates that the first virtual character is within a visibility range of the another virtual character and the another virtual character is not within a visibility range of the first virtual character.

The training module is further configured to: determine an ideal action of the first virtual character based on the sample character status information and the sample environmental perception information of the first virtual character; and determine the proper action reward as the estimated action execution reward when the estimated character action is consistent with the ideal action.

In some embodiments, the character action includes a turning sub-action.

The training module is configured to: transmit environmental perception rays toward a plurality of directions by using the first virtual character as a starting point, different environmental perception rays being located at a same horizontal height, and the environmental perception rays being reflected along normal directions of the environmental perception rays when the environmental perception rays collide with a surface of an obstacle; when reflection statuses of the environmental perception rays indicate that a projection distance of a first environmental perception ray is less than a distance threshold, determine, as an ideal turning direction, a transmitting direction of an environmental perception ray that is adjacent to the first environmental perception ray and whose projection distance is greater than the distance threshold, the projection distance being a distance between a starting point and a reflection point of the environmental perception ray; and determine the proper action reward as the estimated action execution reward when a turning direction indicated by the turning sub-action is consistent with the ideal turning direction.

In some embodiments, at least one another virtual character exists in a battle to which the first virtual character belongs, and the another virtual character executes an action outputted by a second action decision-making model.

The training module is configured to: when one round of training on a first action decision-making model corresponding to the first virtual character is completed, train the second action decision-making model based on a trained first action decision-making model, and store a second action decision-making model obtained through one round of training to an opponent model pool; select the trained second action decision-making model from the opponent model pool, and construct a new battle, the new battle including the first virtual character that executes an estimated character action outputted by the first action decision-making model and the another virtual character that executes an estimated character action outputted by the second action decision-making model; and train the first action decision-making model in the new battle.

In some embodiments, the training model is configured to: obtaining battle data of an i^{th} round of training battle when an i^{th} round of training on the action decision-making model is completed; determine a battle indicator and a personification indicator based on battle data of at least two rounds of training battles, the personification indicator being an actual execution proportion of a specific action in the battle data of at least the training battles; and when the battle indicator reaches a training completion criterion and the personification indicator matches an action execution proportion of executing the specific action by a real player in a battle, determine that training on the action decision-making model is completed.

To sum up, when action decision-making needs to be performed on a first virtual character in a virtual environment, character status information and multimodal environmental perception information of the first virtual character are obtained, so that feature coding and fusion are performed on the character status information and the multimodal environmental perception information, and action decision-making is finally performed based on the fusion feature. During action decision-making, environmental perception information of different information dimensions that is perceived by the first virtual character is obtained. This helps obtain a more comprehensive and detailed three-dimensional virtual environment around the first virtual character, so that more appropriate action decision-making can be performed. Feature coding is performed on the character status information and perception information of a plurality of different modalities by using different coding schemes, so that an action decision-making model can more accurately fit various types of information in a current scenario. In addition, compared with a manner of obtaining an environment feature through image recognition in the related art, feature extraction is performed on quantized multimodal environmental perception information, and then a coding result of the character status information is fused. This helps more comprehensively consider the character status information of the first virtual character while quantizing the environmental perception information, to improve accuracy of a character action obtained through decision-making while saving computing resources, and make effect of executing the character action by the first virtual character more vivid.

FIG. 19 is a schematic structural diagram of a computer device according to an exemplary embodiment of this application. The computer device may be implemented as the terminal or the server in the foregoing embodiments. Specifically, the computer device 1900 includes a central processing unit (CPU) 1901, a system memory 1904 including a random access memory 1902 and a read-only memory 1903, and a system bus 1905 connecting the system memory 1904 and the CPU 1901. The computer device 1900 further includes a basic input/output (I/O) system 1906 assisting in information transmission between components in the computer, and a mass storage device 1907 configured to store an operating system 1913, an application program 1914, and other program modules 1915.

In some embodiments, the basic I/O system 1906 includes a display 1908 configured to display information, and an input device 1909, such as a mouse or a keyboard, configured to input information by a user. The display 1908 and the input device 1909 are both connected to the CPU 1901 through an I/O controller 1910 connected to the system bus 1905. The basic I/O system 1906 may further include the I/O controller 1910 to be configured to receive and process inputs from a plurality of other devices such as a keyboard, a mouse, and an electronic stylus. Similarly, the I/O controller 1910 further provides an output to a display screen, a printer, or another type of output device. The mass storage device 1907 is connected to the CPU 1901 through a mass storage controller (not shown) connected to the system bus 1905. The mass storage device 1907 and a computer-readable medium associated therewith provide non-volatile storage for the computer device 1900. That is, the mass storage device 1907 may include the computer-readable medium (not shown) such as a hard disk or a drive.

The memory has one or more programs stored therein. The one or more programs are configured to be executed by one or more CPUs 1901. The one or more programs include instructions for implementing the foregoing methods. The CPU 1901 executes the one or more programs to implement the methods provided in the foregoing method embodiments. According to the embodiments of this application, the computer device 1900 may be further connected, through a network such as the Internet, to a remote computer on the network and run. To be specific, the computer device 1900 may be connected to a network 1912 through a network interface unit 1911 connected to the system bus 1905, or may be connected to another type of network or a remote computer system (not shown) through a network interface unit 1911. The memory further includes one or more programs. The one or more programs are stored in the memory, and the one or more programs include operations for performing the method provided in the embodiments of this application and performed by the computer device.

Embodiments of this application further provide a non-transitory computer-readable storage medium. The computer-readable storage medium has at least one instruction, at least one program, a code set, or an instruction set stored therein. The at least one instruction, the at least one program, the code set, or the instruction set is loaded and executed by a processor to implement the action decision-making method for a virtual character according to any one of the foregoing embodiments.

Embodiments of this application provide a computer program product or a computer program. The computer program product or the computer program includes computer instructions, and the computer instructions are stored in a non-transitory computer-readable storage medium. A processor of a computer device reads the computer instructions from the computer-readable storage medium, and the processor executes the computer instructions, to enable the computer device to perform the action decision-making method for a virtual character according to the foregoing aspect.

A person of ordinary skill in the art may understand that all or some of the operations of the methods in the embodiments may be implemented by a program instructing relevant hardware. The program may be stored in a non-transitory computer-readable storage medium. The computer-readable storage medium may be the computer-readable storage medium included in the memory in the foregoing embodiment, or may be a non-transitory computer-readable storage medium that exists independently and that is not assembled in a terminal. The computer-readable storage medium has at least one instruction, at least one program, a code set, or an instruction set stored therein. The at least one instruction, the at least one program, the code set, or the instruction set is loaded or executed by a processor to implement the action decision-making method for a virtual character according to any one of the foregoing method embodiments.

In some embodiments, the computer-readable storage medium may include: a ROM, a RAM, a solid-state drive (SSD), an optical disk, or the like. A person of ordinary skill in the art may understand that all or some of the operations of the foregoing embodiments may be implemented by hardware, or may be implemented by a program instructing relevant hardware. The program may be stored in a non-transitory computer-readable storage medium. The storage medium may be a read-only memory, a magnetic disk, an optical disc, or the like.

Information (including but not limited to user equipment information, user personal information, and the like), data (including but not limited to data for analysis, data for storage, data for display, and the like), and signals involved in this application are all authorized by users or fully authorized by all parties, and collection, use, and processing of relevant data need to comply with relevant laws, regulations, and standards of relevant regions. In addition, a prompt interface or a pop-up window may be displayed, or voice prompt information may be outputted before and during collecting user-related data. The prompt interface, the pop-up window, or the voice prompt information is configured for notifying the user that data related to the user is currently being collected. Therefore, in this application, related operations of obtaining the user-related data start to be performed only after a confirmation operation of the user for the prompt interface or the pop-up window is obtained; otherwise, the related operations of obtaining the user-related data are ended, in other words, the user-related data is not obtained.

“A plurality of” mentioned in this specification means two or more. “First”, “second”, and the like mentioned in this specification are intended to distinguish between similar objects, but not to define a specific order or sequence. In addition, the operation numbers described in this specification merely exemplarily show a possible execution sequence of the operations. In some other embodiments, the operations may alternatively not be performed according to the number sequence. For example, two operations with different numbers may be performed simultaneously, or two operations with different numbers may be performed according to a sequence opposite to the sequence shown in the figure. This is not limited in the embodiments of this application.

In the embodiments of this application, the term “module” refers to a computer program with a preset function or a part of the computer program and works, together with other related parts, to implement a preset target, which may be completely or partially implemented by using software, hardware (such as a processing circuit or a memory) or a combination thereof. Similarly, one processor (or a plurality of processors or memories) may be configured to implement one or more modules. In addition, each module may be a part of an overall module including a function of the module. The foregoing descriptions are merely exemplary embodiments of this application, but are not intended to limit this application. Any modification, equivalent replacement, or improvement made within the spirit and principle of this application shall fall within the protection scope of this application.

What is claimed is:

1. An action decision-making method for a virtual character performed by a computer device, the method comprising:
obtaining character status information of a first virtual character and environmental perception information of the first virtual character with respect to a virtual environment in which the first virtual character is currently located;
fusing the character status information and the environmental perception information into a fusion feature;
determining a character action for the first virtual character by applying the fusion feature to an action decision-making model; and
controlling the first virtual character to execute the character action.

2. The method according to claim 1, wherein the obtaining environmental perception information of the first virtual character with respect to a virtual environment in which the first virtual character is currently located comprises:
obtaining first-modality perception information through ray detection based on a character location of the first virtual character in the virtual environment, and the first-modality perception information being configured for representing a depth status of an obstacle at a same horizontal height around the first virtual character;
obtaining second-modality perception information through ray detection based on the character location of the first virtual character in the virtual environment and an orientation of the first virtual character, and the second-modality perception information being configured for representing a depth status of an obstacle in the orientation direction of the first virtual character; and
obtaining third-modality perception information of the virtual environment within a preset range of the first virtual character through ray detection based on the character location of the first virtual character in the virtual environment, and the third-modality perception information being configured for representing a spatial distribution status of obstacles within the preset range.

3. The method according to claim 2, wherein the obtaining the first-modality perception information through ray detection based on a character location of the first virtual character in the virtual environment comprises:
transmitting environmental perception rays in a plurality of directions by using at least two heights of the character location of the first virtual character as starting points, the environmental perception rays being reflected along normal directions of the environmental perception rays when the environmental perception rays collide with a surface of an obstacle, and transmitting directions of environmental perception rays transmitted at a same height are at a same horizontal height; and
generating the first-modality perception information based on reflection statuses of the environmental perception rays.

4. The method according to claim 2, wherein the obtaining the second-modality perception information through ray detection based on the character location of the first virtual character in the virtual environment and an orientation of the first virtual character comprises:
transmitting an environmental perception ray toward the orientation direction of the first virtual character by using the first virtual character as a starting point, the environmental perception ray being reflected along a normal direction of the environmental perception ray when the environmental perception ray collides with a surface of an obstacle; and
generating the second-modality perception information based on a reflection status of the environmental perception ray.

5. The method according to claim 2, wherein the obtaining the third-modality perception information of the virtual environment within a preset range of the first virtual character through ray detection based on the character location of the first virtual character in the virtual environment comprises:
dividing the virtual environment within the preset range of the first virtual character by using an occupancy grid, the occupancy grid comprising a plurality of cubes with a same volume; and
transmitting environmental perception rays from starting points of at least two directions in the virtual environment to the occupancy grid, and generating the third-modality perception information based on reflection statuses of the environmental perception rays.

6. The method according to claim 1, wherein the fusing the character status information and the environmental perception information, to obtain a fusion feature comprises:
coding the character status information and the environmental perception information to obtain a status information coding result corresponding to the character status information and a perception information coding result corresponding to the environmental perception information;
concatenating the status information coding result and the perception information coding result to obtain a concatenated feature code; and
performing feature extraction on the concatenated feature code to obtain the fusion feature.

7. The method according to claim 1, wherein the action decision-making model is trained by:
obtaining sample character status information of the first virtual character and sample environmental perception information of the first virtual character with respect to the virtual environment in which the first virtual character is currently located;
fusing the sample character status information and the sample environmental perception information, to obtain a sample fusion feature; and
training the action decision-making model based on the sample fusion feature through reinforcement learning.

8. The method according to claim 1, wherein the method further comprises:
determining an ideal action of the first virtual character based on sample character status information and sample environmental perception information of the first virtual character; and
determining a proper action reward according to the ideal action.

9. The method according to claim 8, wherein the character action comprises a turning sub-action; the method further comprises:
transmitting environmental perception rays toward a plurality of directions by using the first virtual character as a starting point, different environmental perception rays being located at a same horizontal height, and the environmental perception rays being reflected along normal directions of the environmental perception rays when the environmental perception rays collide with a surface of an obstacle; and
when reflection statuses of the environmental perception rays indicate that a projection distance of a first environmental perception ray is less than a distance threshold, determining, as an ideal turning direction, a transmitting direction of an environmental perception ray that is adjacent to the first environmental perception ray and whose projection distance is greater than the distance threshold, the projection distance being a distance between a starting point and a reflection point of the environmental perception ray; and
determining the proper action reward as the estimated action execution reward when a turning direction indicated by the turning sub-action is consistent with the ideal turning direction.

10. The method according to claim 1, wherein the method further comprises:
obtaining battle data of an i^{th} round of training battle when an i^{th} round of training on the action decision-making model is completed;
determining a battle indicator and a personification indicator based on battle data of at least two rounds of training battles, the personification indicator being an actual execution proportion of a specific action in the battle data of at least the training battles; and
when the battle indicator reaches a training completion criterion and the personification indicator matches an action execution proportion of executing the specific action by a real player in a battle, determining that training on the action decision-making model is completed.

11. A computer device, the computer device comprising a processor and a memory, the memory having at least one program stored therein, the at least one program being loaded and executed by the processor to implement the action decision-making method for a virtual character including:
obtaining character status information of a first virtual character and environmental perception information of the first virtual character with respect to a virtual environment in which the first virtual character is currently located;
fusing the character status information and the environmental perception information into a fusion feature;
determining a character action for the first virtual character by applying the fusion feature to an action decision-making model; and
controlling the first virtual character to execute the character action.

12. The computer device according to claim 11, wherein the obtaining environmental perception information of the first virtual character with respect to a virtual environment in which the first virtual character is currently located comprises:
obtaining first-modality perception information through ray detection based on a character location of the first virtual character in the virtual environment, and the first-modality perception information being configured for representing a depth status of an obstacle at a same horizontal height around the first virtual character;
obtaining second-modality perception information through ray detection based on the character location of the first virtual character in the virtual environment and an orientation of the first virtual character, and the second-modality perception information being configured for representing a depth status of an obstacle in the orientation direction of the first virtual character; and
obtaining third-modality perception information of the virtual environment within a preset range of the first virtual character through ray detection based on the character location of the first virtual character in the virtual environment, and the third-modality perception information being configured for representing a spatial distribution status of obstacles within the preset range.

13. The computer device according to claim 12, wherein the obtaining the first-modality perception information through ray detection based on a character location of the first virtual character in the virtual environment comprises:
transmitting environmental perception rays in a plurality of directions by using at least two heights of the character location of the first virtual character as starting points, the environmental perception rays being reflected along normal directions of the environmental perception rays when the environmental perception rays collide with a surface of an obstacle, and transmitting directions of environmental perception rays transmitted at a same height are at a same horizontal height; and
generating the first-modality perception information based on reflection statuses of the environmental perception rays.

14. The computer device according to claim 12, wherein the obtaining the second-modality perception information through ray detection based on the character location of the first virtual character in the virtual environment and an orientation of the first virtual character comprises:
transmitting an environmental perception ray toward the orientation direction of the first virtual character by using the first virtual character as a starting point, the environmental perception ray being reflected along a normal direction of the environmental perception ray when the environmental perception ray collides with a surface of an obstacle; and
generating the second-modality perception information based on a reflection status of the environmental perception ray.

15. The computer device according to claim 12, wherein the obtaining the third-modality perception information of the virtual environment within a preset range of the first virtual character through ray detection based on the character location of the first virtual character in the virtual environment comprises:
dividing the virtual environment within the preset range of the first virtual character by using an occupancy grid, the occupancy grid comprising a plurality of cubes with a same volume; and
transmitting environmental perception rays from starting points of at least two directions in the virtual environment to the occupancy grid, and generating the third-modality perception information based on reflection statuses of the environmental perception rays.

16. The computer device according to claim 11, wherein the fusing the character status information and the environmental perception information, to obtain a fusion feature comprises:
coding the character status information and the environmental perception information to obtain a status information coding result corresponding to the character status information and a perception information coding result corresponding to the environmental perception information;
concatenating the status information coding result and the perception information coding result to obtain a concatenated feature code; and
performing feature extraction on the concatenated feature code to obtain the fusion feature.

17. The computer device according to claim 11, wherein the action decision-making model is trained by:
obtaining sample character status information of the first virtual character and sample environmental perception information of the first virtual character with respect to the virtual environment in which the first virtual character is currently located;
fusing the sample character status information and the sample environmental perception information, to obtain a sample fusion feature; and
training the action decision-making model based on the sample fusion feature through reinforcement learning.

18. The computer device according to claim 11, wherein the method further comprises:
determining an ideal action of the first virtual character based on sample character status information and sample environmental perception information of the first virtual character; and
determining a proper action reward according to the ideal action.

19. The computer device according to claim 11, wherein the method further comprises:
obtaining battle data of an i^{th} round of training battle when an i^{th} round of training on the action decision-making model is completed;
determining a battle indicator and a personification indicator based on battle data of at least two rounds of training battles, the personification indicator being an actual execution proportion of a specific action in the battle data of at least the training battles; and
when the battle indicator reaches a training completion criterion and the personification indicator matches an action execution proportion of executing the specific action by a real player in a battle, determining that training on the action decision-making model is completed.

20. A non-transitory computer-readable storage medium, the readable storage medium having at least one program stored therein, and the at least one program, when being loaded and executed by a processor of a computer device, causing the computer device to implement an action decision-making method for a virtual character including:
obtaining character status information of a first virtual character and environmental perception information of the first virtual character with respect to a virtual environment in which the first virtual character is currently located;
fusing the character status information and the environmental perception information into a fusion feature;
determining a character action for the first virtual character by applying the fusion feature to an action decision-making model; and
controlling the first virtual character to execute the character action.
